(19) United States
(12) Patent Application Publication
(10) Pub. No.: US 2021/0272706 A1
(43) Pub. Date: Sep. 2, 2021

(54) System and method for phonon-mediated excitation and de-excitation of nuclear states

(71) Applicant: CAMBRIDGE PHONON SYSTEMS, INC, Cambridge, MA (US)

(72) Inventors: FLORIAN METZLER, CAMBRIDGE, MA (US); PETER HAGELSTEIN, CARLISLE, MA (US)

(73) Assignee: CAMBRIDGE PHONON SYSTEMS, INC, CAMBRIDGE, MA (US)

(21) Appl. No.: 15/733,950

(22) PCT Filed: Jun. 3, 2019
(86) PCT No.: PCT/US2019/035147

§ 371 Date: Dec. 1, 2020

Related U.S. Application Data
(60) Provisional application No. 62/679,974, filed on Jun. 3, 2018.
(60) Provisional application No. 62/680,579, filed on Jun. 4, 2018.
(60) Provisional application No. 62/681,088, filed on Jun. 5, 2018.
(60) Provisional application No. 62/806,071, filed on Feb. 15, 2019.
(60) Provisional application No. 62/822,790, filed on Mar. 23, 2019.
(60) Provisional application No. 62/822,970, filed on Mar. 24, 2019.

(30) Foreign Application Priority Data
Jun. 4, 2018 (US) PCT/US2018/035883

(51) Int. Cl. G21B 1/19; G21B 1/00

(52) U.S. Cl. CPC G21B 1/19; G21B 1/00

(57) ABSTRACT

The present invention relates to a system for a system for generating energetic particles including a device for generating an ion beam comprising a first group of atomic nuclei, and a condensed matter medium comprising a second group of atomic nuclei. The ion beam is configured to interact with the condensed matter medium so that some atomic nuclei of the first group of atomic nuclei are implanted into the condensed matter medium and undergo a first nuclear reaction thereby releasing a first energy. The ion beam is further configured to generate high-frequency phonons in the condensed matter medium. The high-frequency phonons are configured to interact with the second group of atomic nuclei and affect nuclear states of the second group of atomic nuclei by transferring the first energy of the first group of atomic nuclei to the second group of atomic nuclei and causing the second group of atomic nuclei to undergo a second nuclear reaction and emit energetic particles.

### CROSS REFERENCE TO RELATED CO-PENDING APPLICATIONS

This application claims the benefit of WIPO nonprovisional application Serial No. PCT/US2018/35883 filed Jun. 4, 2018 and entitled “System and method for generating photon emission from atomic nuclei”, the contents of which are expressly incorporated herein by reference.

This application claims the benefit of U.S. provisional application Ser. No. 62/679,974 filed Jun. 3, 2018 and entitled “Methods and systems for phonon-nuclear coupling based effects”, the contents of which are expressly incorporated herein by reference.

This application claims the benefit of U.S. provisional application Ser. No. 62/680,579 filed Jun. 4, 2018 and entitled “Methods and systems for affecting nuclear reaction rates in condensed matter media”, the contents of which are expressly incorporated herein by reference.

This application claims the benefit of U.S. provisional application Ser. No. 62/681,088 filed Jun. 5, 2018 and entitled “System, method and apparatus for generating energetic particles”, the contents of which are expressly incorporated herein by reference.

This application claims the benefit of U.S. provisional application Ser. No. 62/806,071 filed Feb. 15, 2019 and entitled “System and Method for Causing Phonon-Nuclear Interactions with Macroscopic Effects”, the contents of which are expressly incorporated herein by reference.

This application claims the benefit of U.S. provisional application Ser. No. 62/822,790 filed Mar. 23, 2019 and entitled “System and Method for Nuclear Excitation Transfer”, the contents of which are expressly incorporated herein by reference.

This application claims the benefit of U.S. provisional application Ser. No. 62/822,970 filed Mar. 24, 2019 and entitled “System and Method for Measuring Vibrations in Condensed Matter”, the contents of which are expressly incorporated herein by reference.

### FIELD OF THE INVENTION

The present invention relates to a system and method for exciting and de-exciting atomic nuclei and in particular to a system and method for transferring excitation energy to and from atomic nuclei via phonon-mediated nuclear excitation transfer, encompassing such applications as the production of charged particle emission.

### BACKGROUND OF THE INVENTION

The atomic nucleus continues to be of great scientific and practical interest as it determines the macroscopic properties of materials and comprises binding energy between its constituent nucleons which can be released through nuclear reactions such as fission and fusion. Despite their significance, many aspects of atomic nuclei remain insufficiently understood. This includes the detailed structure of nuclei as well as the range of interactions between nuclei and their environment. The incompleteness of present-day knowledge on atomic nuclei is reflected in the failure of present-day nuclear structure models to predict with high accuracy empirically known radiative decay rates across a wide range of nuclear species.

Referring to FIG. 1, excitation and de-excitation of atomic nuclei typically takes place through the absorption or emission of energy via photons or absorption or emission of energy via energetic particles 101, such as neutrons, charged particles, or photons, among others. The interaction between an energetic particle 101 and an atomic nucleus 102 generates an excited nucleus 104. The excited nucleus 104 decays after a short time and results in the production of reaction products 106. The reaction products 106 include new particles 109 and other nuclei 108a, 108b.

This approach bears a number of constraints: producing photons at sufficient energy levels to excite atomic nuclei tends to require the use of large particle accelerators with associated cost and low efficiency precluding the scalability of many nuclear processes and applications of interest. Similarly, the production of neutrons at appropriate energy levels is often elaborate and inefficient. Additionally, high energy photons and neutrons can be difficult to shield and can thus represent hazards to humans as well as lead to unwanted irradiation of surroundings. Alternative mechanisms to transfer excitation energy to and from atomic nuclei, with the potential of lowering hazard levels and improving scalability and economics would be useful to a range of applications across multiple domains and industries.

### SUMMARY OF THE INVENTION

In general, in one aspect, the invention features system for generating energetic particles including a device for generating an ion beam comprising a first group of atomic nuclei, and a condensed matter medium comprising a second group of atomic nuclei. The ion beam is configured to interact with the condensed matter medium so that some atomic nuclei of the first group of atomic nuclei are implanted into the condensed matter medium and undergo a first nuclear reaction thereby releasing a first energy. The ion beam is further configured to generate high-frequency phonons in the condensed matter medium. The high-frequency phonons are configured to interact with the second group of atomic nuclei and affect nuclear states of the second group of atomic nuclei by transferring the first energy of the first group of atomic nuclei to the second group of atomic nuclei and causing the second group of atomic nuclei to undergo a second nuclear reaction and emit energetic particles.

Implementations of this aspect of the invention may include one or more of the following features. The first nuclear reaction comprises fusion of some of the atomic nuclei of the first group of atomic nuclei. The ion beam has energy in the range of 100 eV to 2000 eV. The system further includes a particle detector for detecting the emitted energetic particles. The condensed matter medium is contained within a vacuum chamber. The condensed matter medium comprises a Lithium foil and the second group of atomic nuclei comprises Li-6 nuclei. The first group of atomic nuclei comprises deuterium (H-2) and protium (H-1) nuclei. The emitted energetic particles comprise tritium (H-3) and Helium-4 (He-4) nuclei. The first group of atomic nuclei comprises deuterium (H-2) and protium (H-1) nuclei, the second group of atomic nuclei comprises Li-6 nuclei and the first nuclear reaction comprises fusion of the H-2 and H-1 nuclei resulting in the release of 5.5 MeV of nuclear binding energy and the second nuclear reaction comprises decay of the Li-6 nuclei resulting in emission of energetic particles having an energy of 1.1 MeV. The first group of atomic nuclei comprises deuterium (H-2) and protium (H-1) nuclei, the second group of atomic nuclei comprises Pb-204 nuclei and the first nuclear reaction comprises fusion of the H-2 and H-1 nuclei resulting in the release of 5.5 MeV of nuclear binding energy and the second nuclear reaction comprises decay of the Pb-204 nuclei resulting in emission of energetic particles having an energy of 7.3 MeV. The first nuclear reaction further emits energetic particles having an energy lower than the energy of the energetic particles that are generated by the second nuclear reaction. The energetic particles are charged particles, neutrons, or photons, among others.

In general, in another aspect the invention features a method for generating energetic particles including the following. First, generating an ion beam comprising a first group of atomic nuclei. Next, providing a condensed matter medium comprising a second group of atomic nuclei. Next, interacting the ion beam with the condensed matter medium so that some atomic nuclei of the first group of atomic nuclei are implanted into the condensed matter medium and undergo a first nuclear reaction thereby releasing a first energy. The ion beam is further configured to generate high-frequency phonons in the condensed matter medium. Finally, interacting the high-frequency phonons with the second group of atomic nuclei and affecting nuclear states of the second group of atomic nuclei by transferring the first energy of the first group of atomic nuclei to the second group of atomic nuclei and causing the second group of atomic nuclei to undergo a second nuclear reaction and emit energetic particles.

In general, in another aspect the invention features a system for generating energetic particles including a condensed matter medium and a phonon generator. The condensed matter medium comprises a first group of atomic nuclei and a second group of atomic nuclei. The phonon generator is configured to generate high-frequency phonons in the condensed matter medium. Some of the atomic nuclei of the first group undergo a first nuclear reaction thereby releasing a first energy. The high-frequency phonons are configured to interact with the first group of atomic nuclei and the second group of atomic nuclei and affect nuclear states of the second group of atomic nuclei by transferring the first energy of the first group of atomic nuclei to the second group of atomic nuclei and causing the second group of atomic nuclei to undergo a second nuclear reaction and emit energetic particles. The first nuclear reaction comprises one of fission, fusion, or radioactive decay.

### BRIEF DESCRIPTION OF THE DRAWINGS

Referring to the figures, wherein like numerals represent like parts throughout the several views:

FIG. 1 illustrates schematically a process of exciting and de-exciting an atomic nucleus by transferring energy into and out of nuclear states, respectively, via energetic particles;

FIG. 2 illustrates schematically a nuclear excitation transfer process between a donor nucleus and an acceptor nucleus, according to this invention, which results in a new set of reaction products;

FIG. 3 illustrates schematically a nuclear excitation transfer between two Fe-57 nuclei (Nucleus A 301 to Nucleus B 302) affecting the Fe-57 14.4 keV nuclear transition, according to this invention;

FIG. 4 illustrates schematically a vibrating atomic lattice comprising Fe-56, Fe-57, and Co-57 nuclei where a Co-57 nucleus undergoes beta decay;

FIG. 5 illustrates schematically the vibrating atomic lattice of FIG. 4 where a former Co-57 nucleus is now an excited Fe-57* nucleus after having undergone beta decay;

FIG. 6 illustrates schematically the vibrating atomic lattice of FIG. 4 and FIG. 5 and illustrates the phonon-mediated transfer of nuclear excitation from an excited Fe-57* nucleus to a ground state Fe-57 nucleus (which undergoes excitation by the transfer);

FIG. 7 illustrates schematically the vibrating atomic lattice of FIG. 4, FIG. 5 and FIG. 6 and illustrates the de-excitation of an excited Fe-57* nucleus via conventional photon emission (after having previously undergone excitation via phonon-mediated nuclear excitation transfer);

FIG. 8 depicts an exemplary apparatus for generating and monitoring changes in the spatial and angular distribution of photon emission via phonon-mediated nuclear excitation transfer;

FIG. 9 illustrates schematically a vibrating atomic lattice comprising Li-6 and Li-7 nuclei with implanted and incoming energetic H-2 nuclei (via ion beam bombardment) and lattice defects (also via ion beam bombardment);

FIG. 10 illustrates schematically the vibrating atomic lattice of FIG. 9 where two H-2 nuclei undergo a fusion reaction, resulting in a He-4 nucleus and the release of a quantum of nuclear binding energy (24 MeV);

FIG. 11 illustrates schematically the vibrating atomic lattice of FIG. 9 and FIG. 10 where the nuclear binding energy released from a fusion reaction transfers to a Li-7 nucleus via phonon-mediated nuclear excitation transfer, thereby placing it in an excited state;

FIG. 12 illustrates schematically the vibrating atomic lattice of FIG. 9, FIG. 10 and FIG. 11 where an excited Li-7 nucleus (after having previously undergone excitation via phonon-mediated nuclear excitation transfer) undergoes decay by disintegration into a H-3 and He-4 nuclei with kinetic energy (energetic particles);

FIG. 13 depicts an exemplary apparatus for generating and monitoring energetic particle emission via phonon-mediated nuclear excitation transfer;

FIG. 14 depicts graphically the calculated kinetic energies of alpha particles emitted from nuclei of initial mass number A when disintegrating after accepting nuclear excitation from D+D fusion (24 MeV) via phonon-mediated nuclear excitation transfer;

FIG. 15 depicts graphically the calculated kinetic energies of neutrons emitted from nuclei of initial mass number A when disintegrating after accepting nuclear excitation from D+D fusion (24 MeV) via phonon-mediated nuclear excitation transfer;

FIG. 16 depicts graphically the calculated kinetic energies of alpha particles emitted from nuclei of initial mass number A when disintegrating after accepting nuclear excitation from D+P fusion (5.5 MeV) via phonon-mediated nuclear excitation transfer;

FIG. 17 depicts graphically the calculated kinetic energies of protons emitted from nuclei of initial mass number A when disintegrating after accepting nuclear excitation from D+P fusion (5.5 MeV) via phonon-mediated nuclear excitation transfer;

FIG. 18 depicts graphically the calculated kinetic energies of neutrons emitted from nuclei of initial mass number A when disintegrating after accepting nuclear excitation from D+P fusion (5.5 MeV) via phonon-mediated nuclear excitation transfer;

FIG. 19 illustrates schematically the process of splitting a deformed nucleus through increased rotation (i.e. occupying higher energy rotational states);

FIG. 20 illustrates graphically a “ladder” of high energy rotational states in atomic nuclei and their role in inducing fission;

FIG. 21 illustrates graphically the relationship between E and I in the course of coherent fission;

FIG. 22 provides a qualitative overview of phonon-nuclear coupling strength determinants, specifically the relative impact of changing phonon-nuclear coupling matrix element magnitudes on phonon-nuclear coupling strength, the modality of nuclear excitation transfer and resulting effects;

FIG. 23 provides another qualitative overview of phonon-nuclear coupling strength determinants, specifically the relative impact of the size of nuclear transition quanta on phonon-nuclear coupling strength, the modality of nuclear excitation transfer and resulting effects;

FIG. 24 provides a block diagram of an overview of dependencies for determining and optimizing nuclear excitation transfer parameters which inform system design, and specifically the lattice configuration, for nuclear excitation transfer-based application systems;

FIG. 25 is a block diagram that summarizes the design process for nuclear excitation transfer-based charged particle production systems; and

FIG. 26 is a block diagram that summarizes the general design process for nuclear excitation transfer-based systems.

### DETAILED DESCRIPTION OF THE INVENTION

In the international patent application PCT/US2018/35883, the contents of which are expressly incorporated herein by reference, we described a system and method for nuclear excitation transfer based on a phonon-nuclear interaction which was first demonstrated and characterized by our experiments.

The present invention relates to a system and a method for exciting and de-exciting atomic nuclei and in particular to a system and method for transferring excitation energy to and from atomic nuclei via phonon-mediated nuclear excitation transfer, encompassing such applications as the generation of charged particle emission. Specifically, the invention teaches novel applications resulting from the transfer of energy into and out of excited nuclear states via phonon interactions.

### 1. Introduction

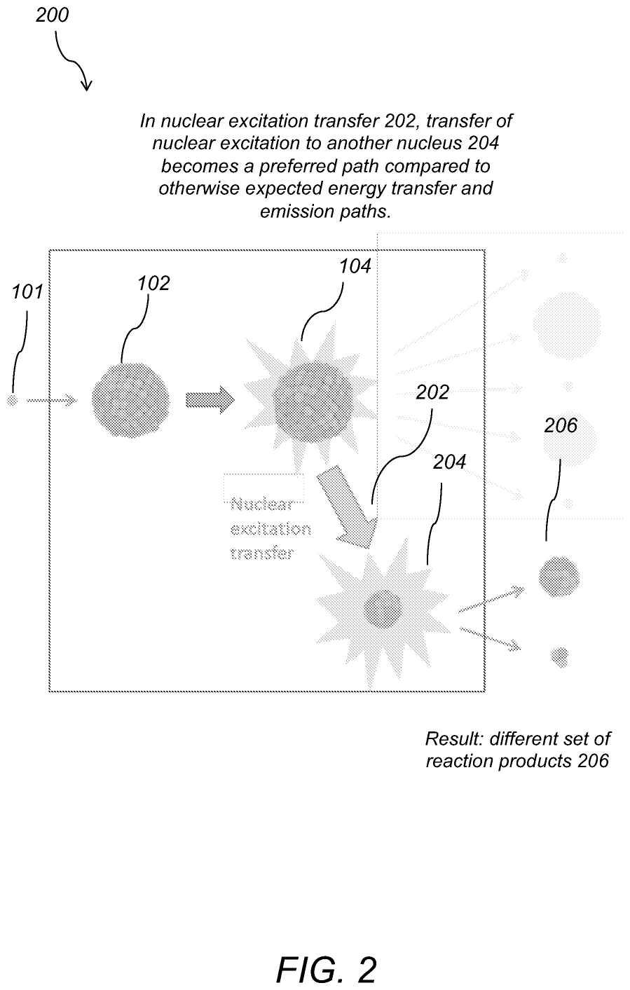

Phonon-nuclear interactions follow from a required boost correction of the nucleon-nucleon interaction inside the atomic nucleus when a nucleus is accelerated or decelerated, as is the case when it oscillates in an atomic lattice. The resulting coupling between lattice oscillations, also described as phonons, and internal nuclear states leads to the temporary formation of a quantum system (comprising the affected nuclei and phonons) within which energy can transfer non-radiatively. One outcome of the formation of such a quantum system of coupled nuclei and phonon modes is the transfer of energy from one group of nuclei (donors) 104 to another group of nuclei (acceptors) 204, a process that is described as nuclear excitation transfer 202, as shown in FIG. 2. When coherence of the quantum system is maintained long enough, energy can also occupy intermediate, off-resonant states (also described as virtual states) and transfer from nuclei to phonon modes and vice versa.

A phonon is defined as a collective excitation of atoms in a periodic, elastic arrangement of atoms or molecules in condensed matter such as in an atomic lattice of solids. It can be viewed as a quantum of energy associated with a vibrational mode. A vibrational mode describes a particular spatial manifestation of the periodic motion of connected atoms. Associated with an excited mode are a frequency, an amplitude, and a corresponding total energy of the excited mode. Quantum-mechanically, the total energy of the excited mode can be viewed as comprising phonons as quanta of energy. The term phonon mode is used to refer to such a mode. The phonon energy is proportional to the frequency of the phonon mode, which depends on the spatial configuration of atoms. The number of phonons in the excited phonon mode is the total energy of the excited phonon mode divided by the phonon energy. The total energy of the excited phonon mode (and therefore the number of phonons) is proportional to the square of the vibrational amplitude.

An analog process to nuclear excitation transfer is electronic excitation transfer. While nuclear excitation transfer has not been considered until the present invention, electronic excitation transfer is well established and widely applied. It is best known under the name of Forster Resonance Energy Transfer (FRET). In FRET, an atom or molecule couples to a (virtual) photon which also couples to another atom or molecule. Together they form a quantum system within which energy can transfer non-radiatively. Whereas FRET is typically photon-mediated, such energy transfer, on the level of atoms, has also been proposed to occur through phonon-mediation. Examples in the peer-reviewed literature go back to the 1950s and include models that describe phonon-mediated electronic excitation transfer where excitation transfer is to be expected even when the energy of the mediating phonons is substantially lower than the transferred excitation energy. Despite the attention that photon- and phonon-mediated electronic excitation transfer in general, and FRET in particular, had received over recent decades, nuclear excitation transfer and related applications had not been considered a possibility until the present disclosure.

### 2. Overview

The previous section introduced phonon-mediated nuclear excitation transfer as a form of non-radiative energy transfer in a quantum system where atomic nuclei are coupled to excited phonon modes and to other atomic nuclei via excited phonon modes.

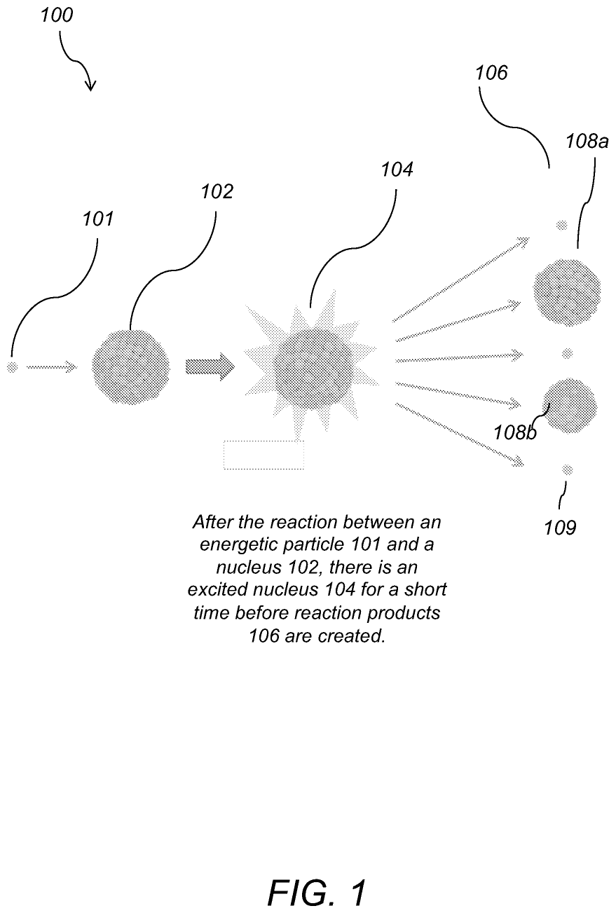

As such, nuclear excitation transfer can form the basis for a number of useful applications. This becomes apparent when considering, for illustrative purposes of the general principle, the transfer of nuclear excitation from a nucleus 102 that is left in an excited state 104 after absorbing a neutron 101, such as is the first step in many common fission reactions, shown in FIG. 1. In a conventional fission reaction, the excited nucleus 104 would then split into smaller nuclei 108a, 108b, typically accompanied by other disintegration products such as neutrons 109, also shown in FIG. 1. However, when the excitation energy of the excited nucleus 104 (donor) is transferred to another nucleus 204 (acceptor) before the fission reaction takes place, then the newly excited acceptor nucleus 204 will undergo decay or fission, resulting in a different set of characteristic products 206, as shown in FIG. 2. Here, the absorption of the neutron 101 by the donor nucleus 102 can be viewed as a primary reaction and the decay of the acceptor nucleus 204 can be viewed as a secondary reaction, whereas the secondary reaction is triggered by the non-radiative transfer of nuclear excitation 202 to the acceptor nucleus 204. Macroscopically, this process results in a different set of reaction products 206 from a system that would otherwise result in conventional fission and thus conventionally expected fission products 106. Transferring nuclear excitation energy to other nuclei in this way is particularly useful when this transfer leads to the avoidance of undesired reaction products such as long-lived actinides, hazardous neutrons or when the transfer leads to the creation of desired reaction products such as energetic particles at specific energies.

How and how efficiently nuclear excitation transfer is applied and achieves specific engineering and design objectives of a system that employs nuclear excitation transfer depends on the implementation of such a system. At the core of such systems are nuclei arranged in a lattice (or an amorphic structure if order is lacking). Second, phonons are generated in the arrangement of nuclei which leads to the formation of quantum systems with coupling between nuclei and nuclei, and between nuclei and phonon modes. The strengths of the resulting phonon-nuclear couplings determines the speed at which energy can transfer—combined with the availability of other energy transfer and conversion channels, this determines where the available energy in the system will go and what macroscopic effects result.

The phonon-nuclear coupling strengths as well as the alternative channels for energy transfer depend on a number of parameters such as the phonon modes of the lattice and their excitation, the phonon energy in the quantum system and in the respective modes, the length of time across which coherence of the coupled quantum system is maintained, the phonon-nuclear coupling matrix elements for the nuclei that participate in the quantum system (in this document also described simply as coupling matrix elements), and the arrangement of nuclei in the lattice (or amorphic structure) which includes their nuclear species (which determines energy levels and relevant cross sections of participating nuclei), their distance and lattice site occupation, their numbers (due to Dicke superradiance which increases coupling strength with increasing numbers of nuclei), and the participation of other nuclei in the quantum system that offer alternative energy transfer and conversion channels (i.e. their presence in the relevant parts of the structure that the donor nuclei can couple to).

A systematic overview of different modalities of nuclear excitation transfer and related application modes that draw on the principle of nuclear excitation transfer is given in the next section. This is followed by a section on the implementation of such applications and a disclosure of relevant engineering and design aspects, including a more detailed discussion of the above-mentioned parameters and their relation to respective operating regimes and application modes. This includes disclosures that guide the choices of materials and structures such as suitable lattice configurations and nuclear species of choice for respective applications, a specific design method for adapting presented exemplary embodiments to a wider range of energetic particles production-related applications, a general design method for nuclear excitation transfer-based systems in general, and other design and application related aspects. Energetic particles include charged particles, neutron, and photons, among others.

A range of different notations are commonly used for describing isotopes of hydrogen. In this document, the expressions protium, P, and H-1 are used to describe a hydrogen nucleus with no neutrons; the expressions deuterium, deuteron, D, and H-2 are used to describe a hydrogen nucleus with one neutron; the expressions tritium, triton, T, and H-3 are used to describe a hydrogen nucleus with three neutrons.

### 3. Modalities of Nuclear Excitation Transfer and Applications

### 3.1. Angular Anisotropy and Delocalization

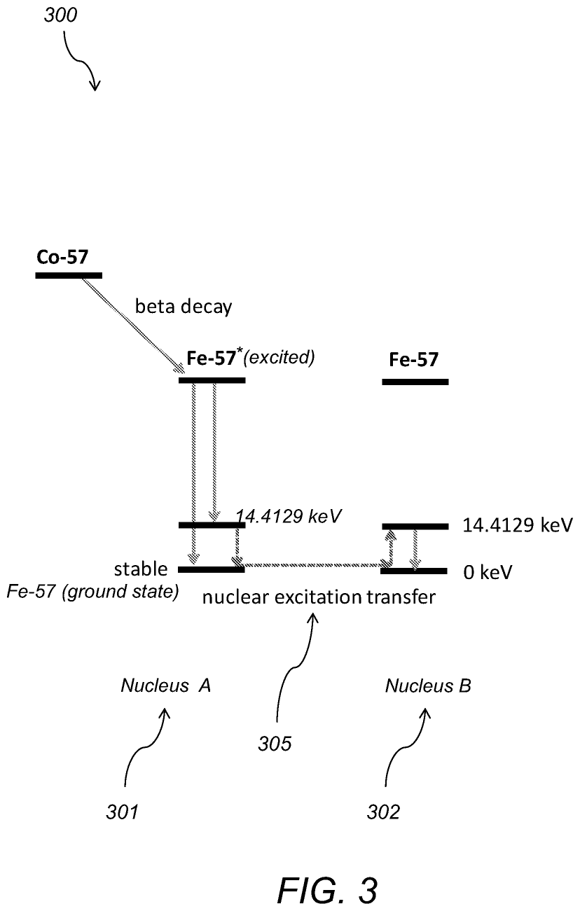

The simplest manifestation of nuclear excitation transfer comprises a system with an excited nucleus and a ground state nucleus of the same nuclear species where both nuclei are coupled through a shared phonon mode. In this case, nuclear excitation can transfer via intermediate states from the excited to the ground state nucleus. An example for such a form of nuclear excitation transfer is shown in FIG. 3 that depicts the energy diagram for a Fe-57 nucleus where the excitation energy of the 14.4 keV excited state of one nucleus A is transferred non-radiatively via phonon-mediated nuclear excitation transfer to nucleus B that is part of the same lattice (and part of the same coupled quantum system in that lattice during the transfer). The figure follows the basic setup of a Jablonski diagram, a visual tool frequently used in atomic physics and biophysics to illustrate energy transitions.

As described in the commonly owned patent application PCT/US2018/358831, nuclear excitation transfer in such a system can lead to such effects as angular anisotropy due to nuclear phase coherence (when the phonon-nuclear coupling strength is comparatively weak and excitation transfer is resonant) and delocalization of emission (when the phonon-nuclear coupling strength is comparatively strong and excitation transfer is non-resonant).

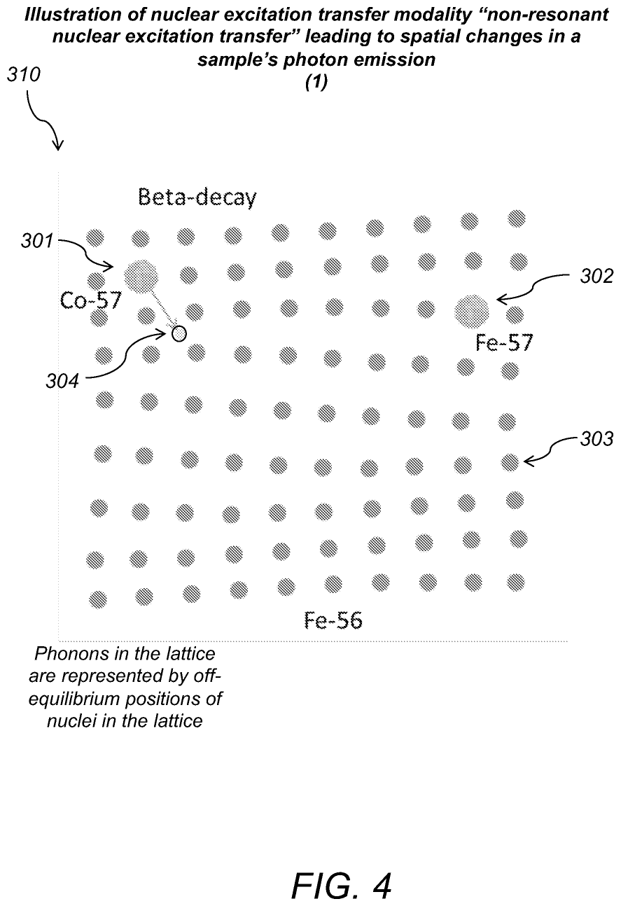

This has been demonstrated in our experiments with Fe-57* (excited state) and Fe-57 (ground state), as reported in PCT/US2018/35883 and in Metzler 2019 “Experiments to Investigate Phonon-Nuclear Interactions” (thesis in the MIT Nuclear Science & Engineering Department available on MIT Dspace). FIGS. 4-7 further illustrate nuclear excitation transfer in a system with said configuration.

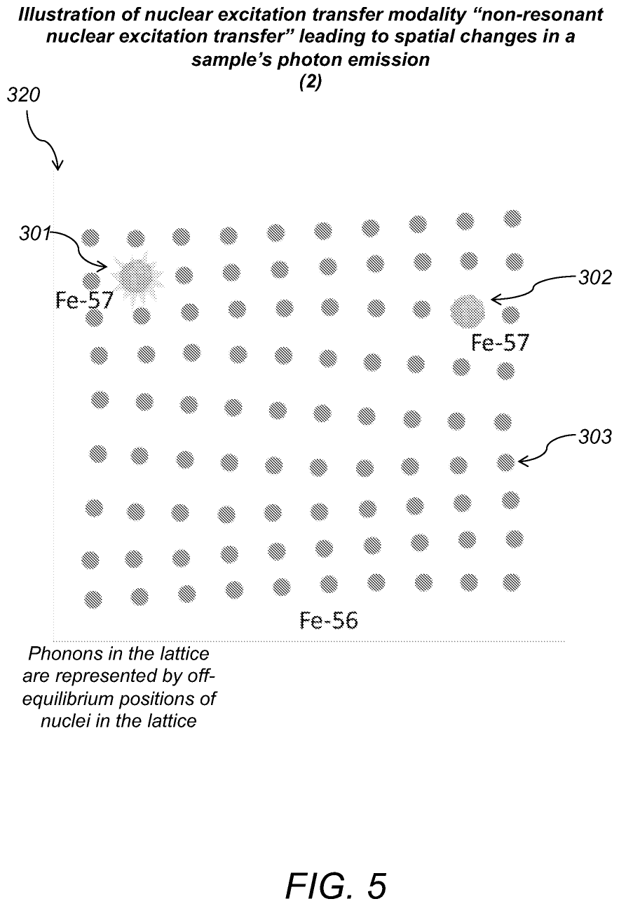

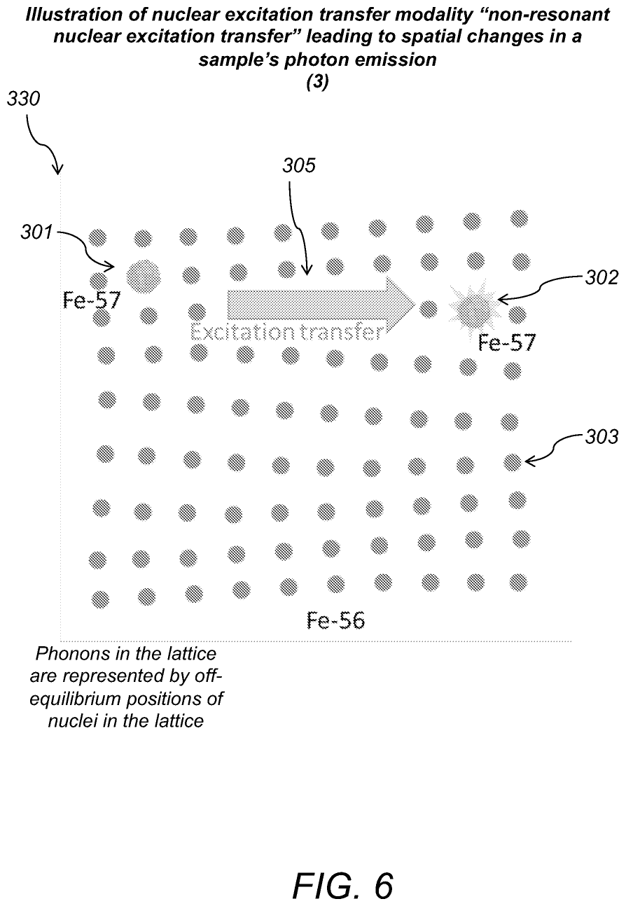

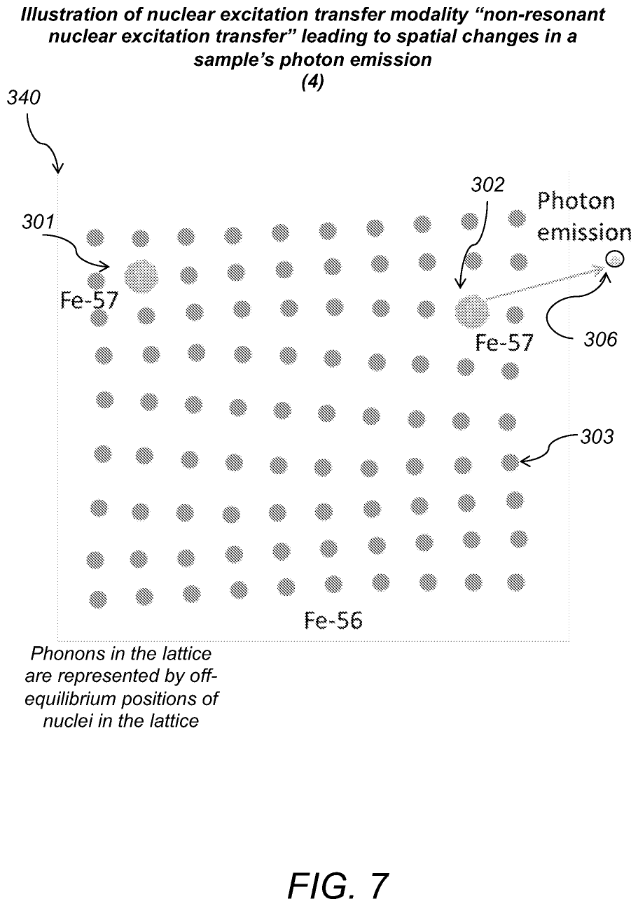

FIG. 4 depicts a vibrating atomic lattice 303 comprising Fe-56, Fe-57, and Co-57 nuclei where a Co-57 nucleus (Nucleus A) 301 undergoes beta decay resulting in the emission of an electron 304. FIG. 5 depicts the vibrating atomic lattice of FIG. 4 where a former Co-57 nucleus 301 is now an excited state Fe-57 nucleus (also described with the notation Fe-57*) 301 after having undergone beta decay. Shortly after the beta decay, the excited Fe-57* nucleus would conventionally de-excite to its ground state via isotropic photon emission from the site of that nucleus. The resulting photon could then be observed as photon emission originating from the location of Nucleus A 301. The above described excited phonon mode that interacts with the nuclei in the figure, enables other outcomes. One alternative outcome is illustrated in FIG. 6. FIG. 6 depicts the vibrating atomic lattice of FIG. 4 and FIG. 5 and illustrates the phonon-mediated transfer of nuclear excitation from an excited Fe-57* nucleus 301 (Nucleus A, the donor nucleus) to a ground state Fe-57 nucleus 302 (Nucleus B, the acceptor nucleus). The excitation energy of the donor nucleus 301 transfers via nuclear excitation transfer 305, mediated by the common phonon mode, to the ground state acceptor nucleus 302 which in this case can accommodate as nuclear excitation the same quantum of energy that de-excited from the donor nucleus. The latter is the case because the energy levels of the donor and receiver nuclei are identical, as both are of the same nuclear species (Fe-57). In this example, the now excited Fe-57* Nucleus B then de-excites conventionally (via radiative decay) and emits a photon, from the site of Nucleus B. FIG. 7 depicts the vibrating atomic lattice of FIG. 4, FIG. 5 and FIG. 6 and illustrates the de-excitation of an excited Fe-57* nucleus via conventional photon emission 306. The photon emission 306 from Nucleus B is demonstrated as originating from a different location than the emission from Nucleus A.

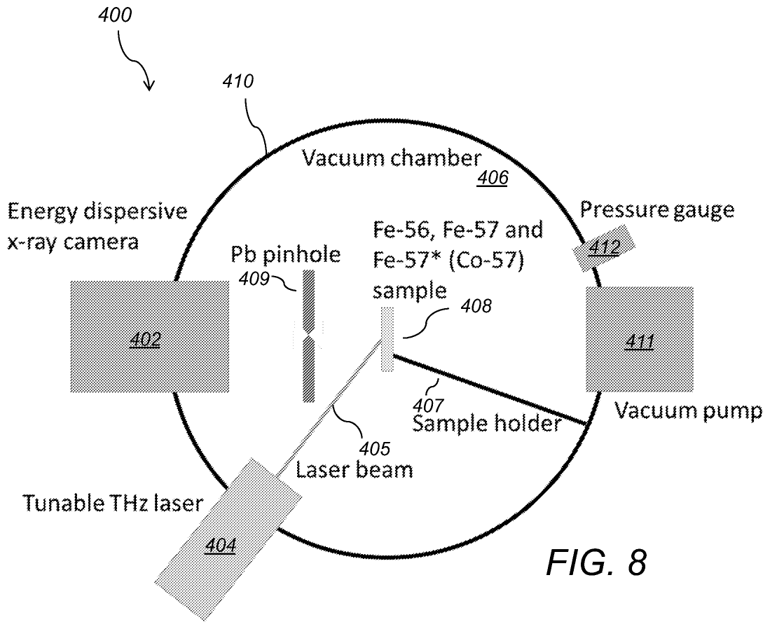

In the described exemplary embodiment in PCT/US2018/35883, phonon generation is triggered by mechanical stress. In the present application, an alternative embodiment is shown in FIG. 8 where the phonon generation i.e. the excitement of phonon modes and thus the formation of coupled quantum systems that involve lattice nuclei is conducted via a laser instead of mechanical stress. This alternative exemplary embodiment is described in detail in section 4.1.2. below.

### 3.2. Change of Nuclear Reaction Products Through Secondary Reaction/Decay

If no (or not enough) matching nuclei with equivalent energy levels are available in the coupled quantum system as acceptors of donor excitation, nuclei of other nuclear species can act as acceptors of excitation energy (as long as they are part of the coupled quantum system and as long as energy transfer to them represents the fastest pathway for energy transfer in the system). Differences between the donor and the acceptor energy quanta can be compensated by emission or absorption of phonons in the surrounding lattice. Again, the phonon-nuclear coupling strengths between the nuclei and phonon modes in the system will determine which channels for energy transfer and conversion are fastest and thus preferred, and consequently, which nuclei or phonon modes donate and accept excitation energy.

If an accepting nucleus in such incidences of nuclear excitation transfer is highly unstable and will break coherence in the quantum system shortly after receiving the energy quantum (for instance via decay), then this form of nuclear excitation transfer is described as incoherent nuclear excitation transfer. An exemplary embodiment of a system exhibiting this form of nuclear excitation transfer is described below. In other words, this process represents the coupling of two nuclear reactions: a primary reaction involving the donor nucleus and resulting in a quantum of excitation energy, and a secondary reaction involving the acceptor nucleus caused by the transfer of the excitation energy to the acceptor.

This approach can be employed in a number of applications with the ability to address a range of desirable engineering outcomes: these include, but are not limited to, disintegration of acceptor nuclei resulting in specific desired charged particle or neutron emission, or alternatively avoidance of specific charged particle or neutron emission.

As to the former case (the production of desired reaction products): an exemplary system that includes a direct electric conversion mechanism may require charged particles at a specific energy range. The inclusion, in the lattice where nuclear excitation transfer takes place, of acceptor nuclei of a nuclear species that yields charged particle emission at the desired energy range addresses such an exemplary system design requirement.

As to the latter case (the suppression of undesired reaction products): an exemplary system that would otherwise be expected to exhibit neutron emission due to nuclei in the system undergoing fusion, fission, or decay reactions may be desired to exhibit no neutron emission. Neutron emission is avoided through the inclusion, in the lattice where nuclear excitation transfer takes place, of acceptor nuclei of a species that accept excitation from donor nuclei whose excitation would otherwise lead to neutron emission and where the acceptor nuclei decay or disintegrate with reaction products other than neutron emission (or, alternatively, other than the energy range of neutron emission to be avoided).

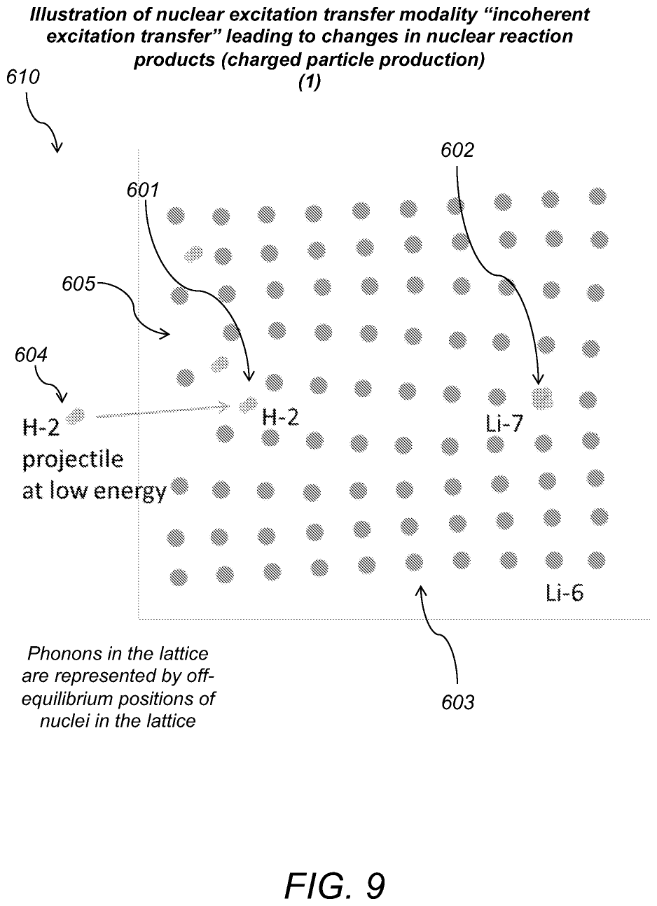

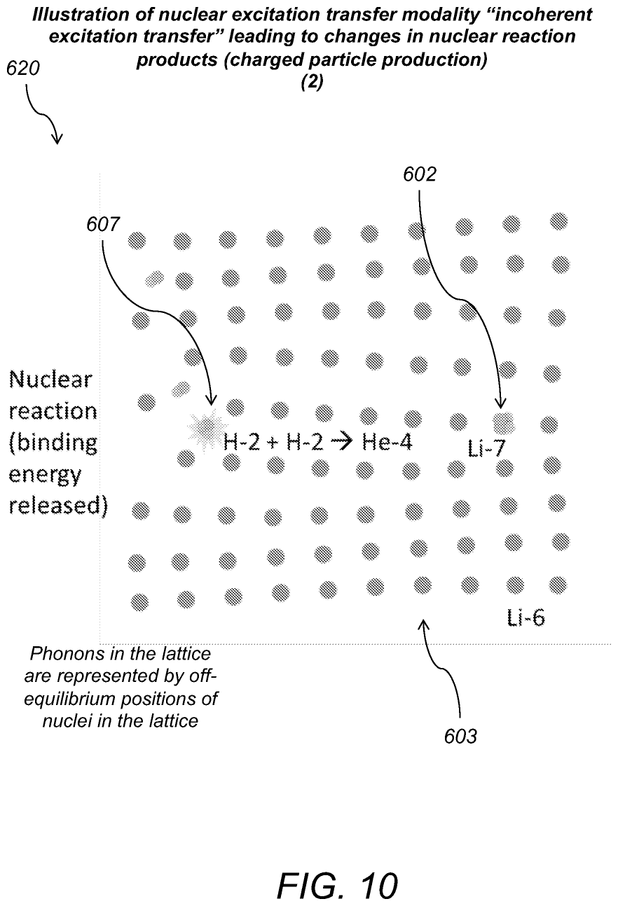

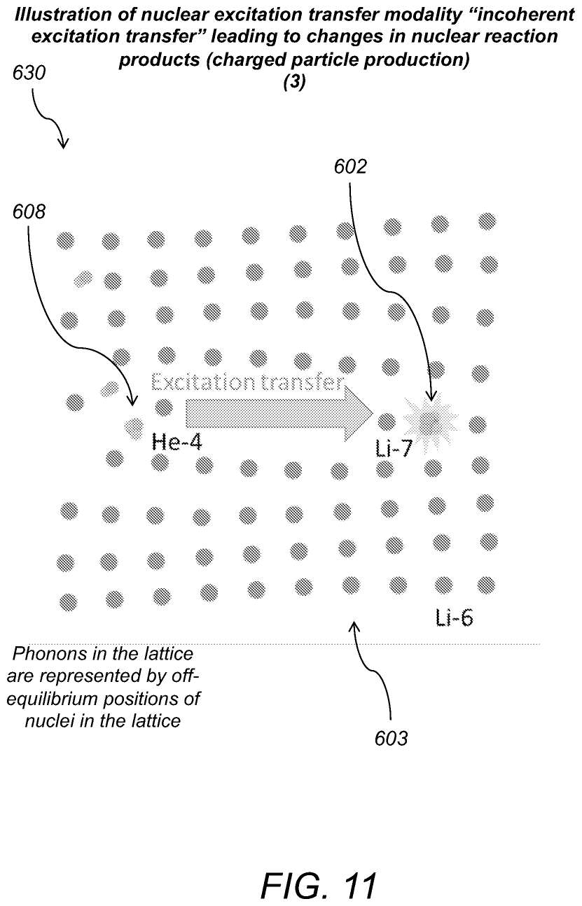

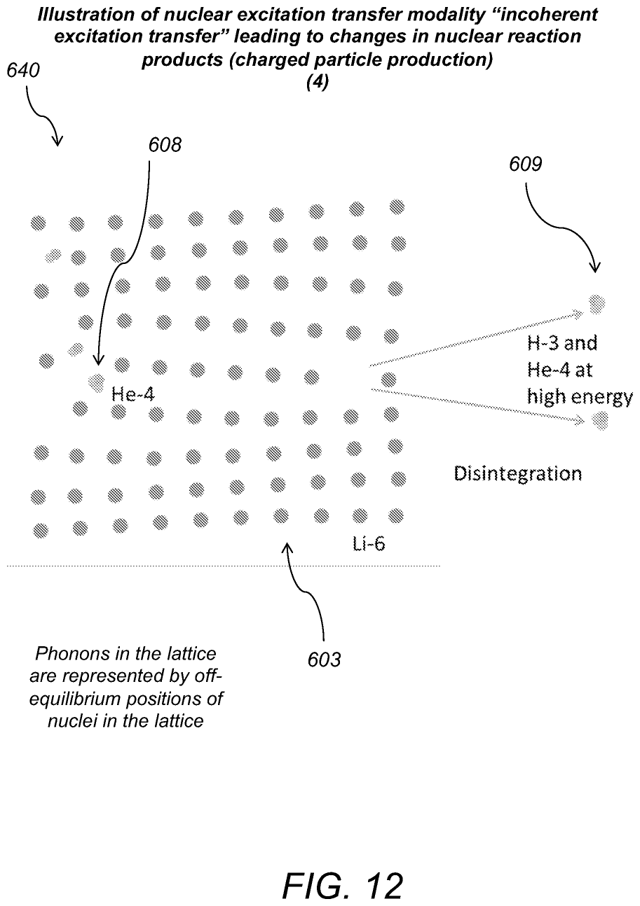

FIGS. 9-12 further illustrates one example of nuclear excitation transfer of the modality “incoherent nuclear excitation transfer” that leads to charged particle production. An example is a system where nuclear binding energy is released through the fusion of two deuterium nuclei H-2+H-2 (as is common in neutron generators). FIG. 9 depicts a vibrating atomic lattice 603 comprising Li-6 and Li-7 nuclei and with implanted and incoming energetic H-2 nuclei—such as illustrated by nucleus (already implanted) 601 and nucleus (incoming energetic) 604—(via ion beam bombardment) and lattice defects—such as illustrated by lattice defect 605—(also via ion beam bombardment); FIG. 10 depicts the vibrating atomic lattice of FIG. 9 where two H-2 nuclei (604 and 601) undergo a fusion reaction, resulting in a He-4 nucleus 608 and the release of a quantum of nuclear binding energy (in this case 24 MeV) 607. Conventionally, i.e. in the absence of nuclear excitation transfer, the fusion reaction would be expected to result in a He-3 nucleus with kinetic energy of approximately 0.8 MeV and a neutron with kinetic energy of approximately 2.5 MeV, or in an H-3 nucleus with kinetic energy of approximately 1 MeV and an H-1 nucleus with kinetic energy of approximately 3.0 MeV, or in a 24 MeV photon. However, if the nuclei undergoing the fusion reaction are coupled via phonon-nuclear coupling to other nuclei in the lattice that can receive the released nuclear binding energy, neutron and gamma emission can be avoided by transferring energy quanta resulting from fusion reactions non-radiatively to acceptor nuclei such as the Li-7 nucleus 602. FIG. 11 depicts the vibrating atomic lattice of FIG. 9 and FIG. 10 where the nuclear binding energy released from a fusion reaction transfers to a Li-7 nucleus 602 via phonon-mediated nuclear excitation transfer, thereby placing that Li-7 nucleus 602 in an excited state; FIG. 12 depicts the vibrating atomic lattice of FIG. 9, FIG. 10 and FIG. 11 where the excited Li-7 nucleus 602 (after having previously undergone excitation via phonon-mediated nuclear excitation transfer) undergoes decay by disintegration into H-3 and He-4 nuclei with kinetic energy (i.e. energetic particles) 609. Whereas the incoming energetic particles (the hydrogen ions, such as nucleus 604) have kinetic energies in the keV and sub-keV range, the resulting energetic particles (such as nuclei 609) have energies in the MeV range (due to the release of nuclear binding energy in the process).

In this example, a lithium foil is used to provide an atomic lattice, and a Li-7 nucleus acts as an acceptor nucleus and receives transferred energy from a fusion reaction by being placed in an excited state. In the case of the H-2+H-2→He-4 fusion reaction, this energy quantum amounts to approximately 24 MeV which is transferred to a nearby Li-7 nucleus and leads to the disintegration of said nucleus resulting in H-3 and He-4 nuclei, as shown in FIG. 12.

The example above describes the case of a system comprising a lithium-hydride lattice that provides acceptor nuclei that can undergo secondary reactions. The application can be generalized to systems comprising other materials. In principle, the system designer needs to consider materials across the chart of nuclides for phonon-mediated nuclear excitation transfer-based applications. Nuclides can be chosen based on their energy levels and associated decay modes/decay chains, their chemical properties, and their cost, among other such parameters.

Specifically, in other embodiments, one or several of the following nuclear species and their isotopes are used as acceptor nuclei in an atomic lattice: H, Li, Be, B, C, N, 0, Na, Mg, Al, Si, P, S, Cl, K, Ca, Sc, Ti, V, Cr, Mn, Fe, Co, Ni, Cu, Zn, Ga, Ge, As, Se, Br, Rb, Sr, Y, Zr, Nb, Mo, Tc, Ru, Rh, Pd, Ag, Cd, In, Sn, Sb, Te, I, Cs, Ba, La, Ce, Pr, Nd, Pm, Sm, Eu, Gd, Tb, Dy, Ho, Er, Tm, Yb, Lu, Hf, Ta, W, Re, Os, Ir, Pt, Au, Hg, Tl, Pb, Bi, Po, At, Fr, Ra, Ac, Th, Pa, U, Np, Pu, Am, Cm, Bk, Cf, Es, Fm.

The arrangement of nuclei in an atomic lattice for nuclear excitation transfer-based applications is described as the “lattice configuration” and the process for designing a suitable lattice configuration for different applications and respective embodiments of the system is described below, including a detailed discussion of a specific and a general system design process as well as selection criteria for nuclear species to be included in the system and other system parameters.

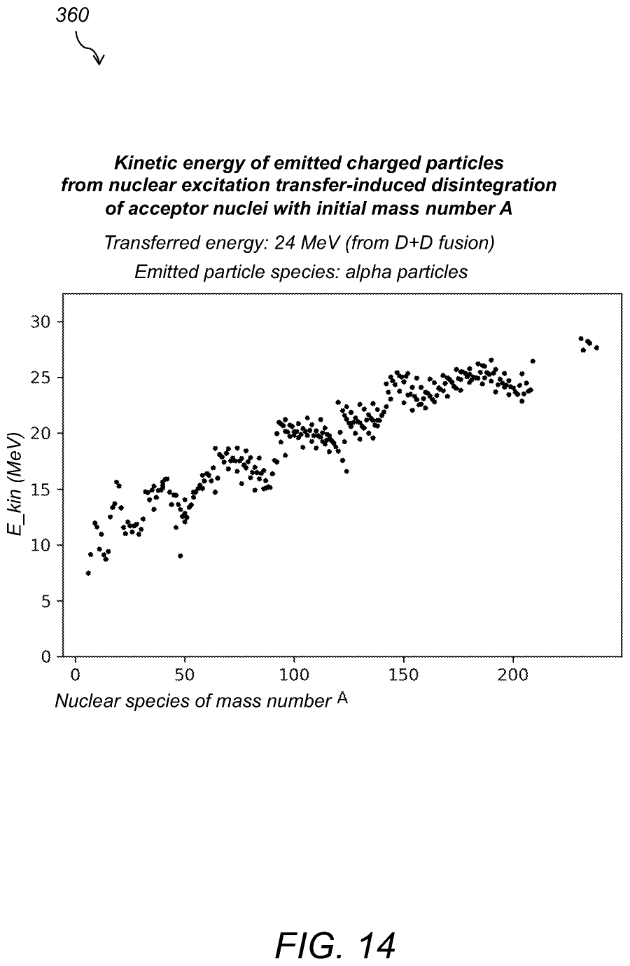

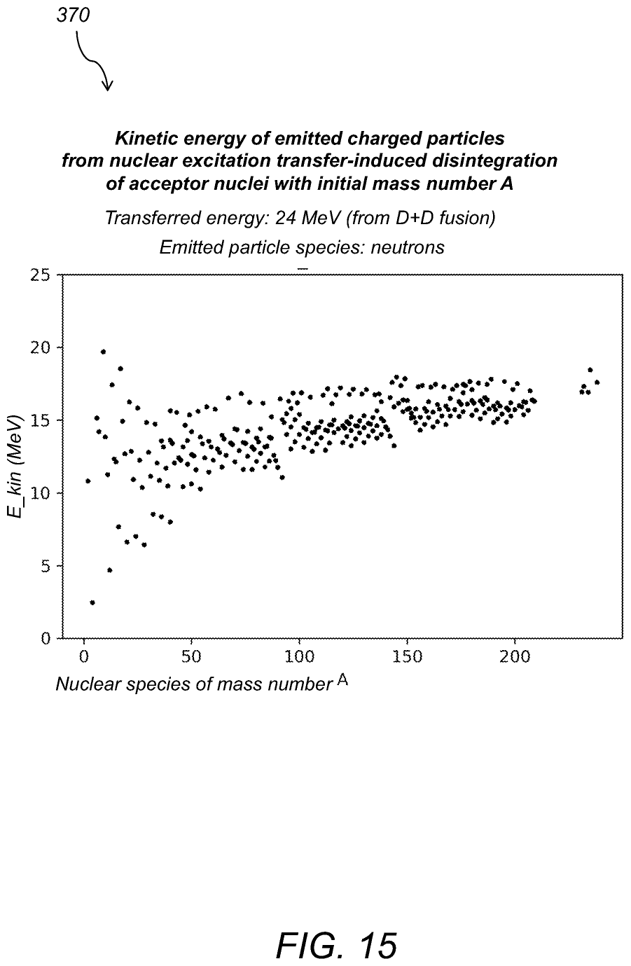

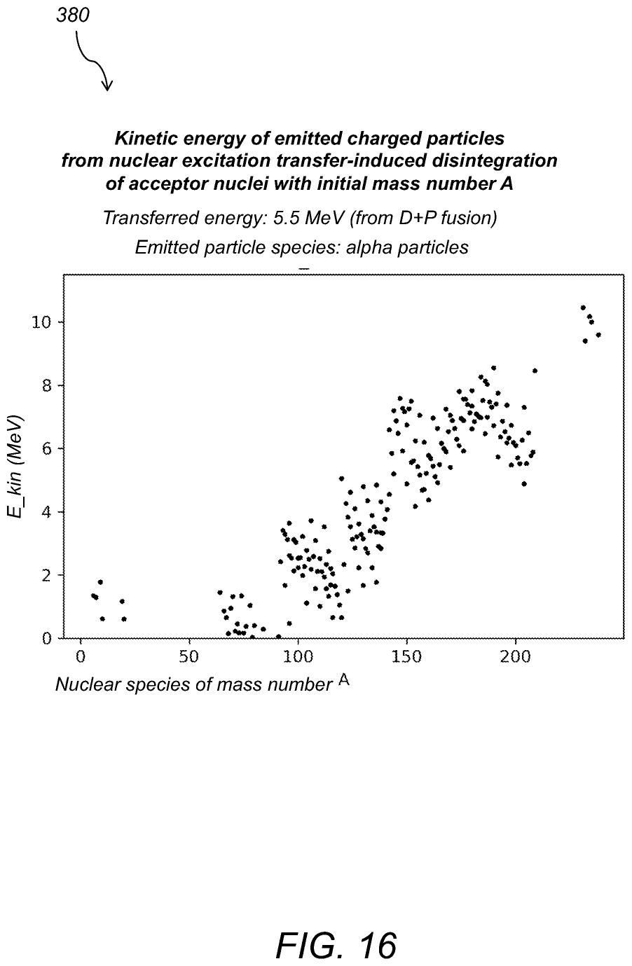

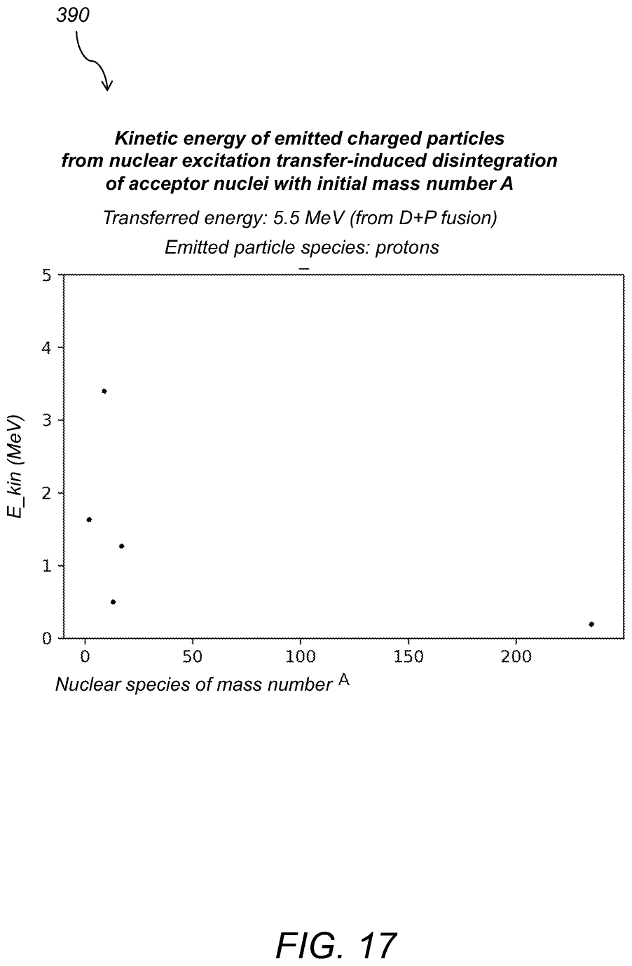

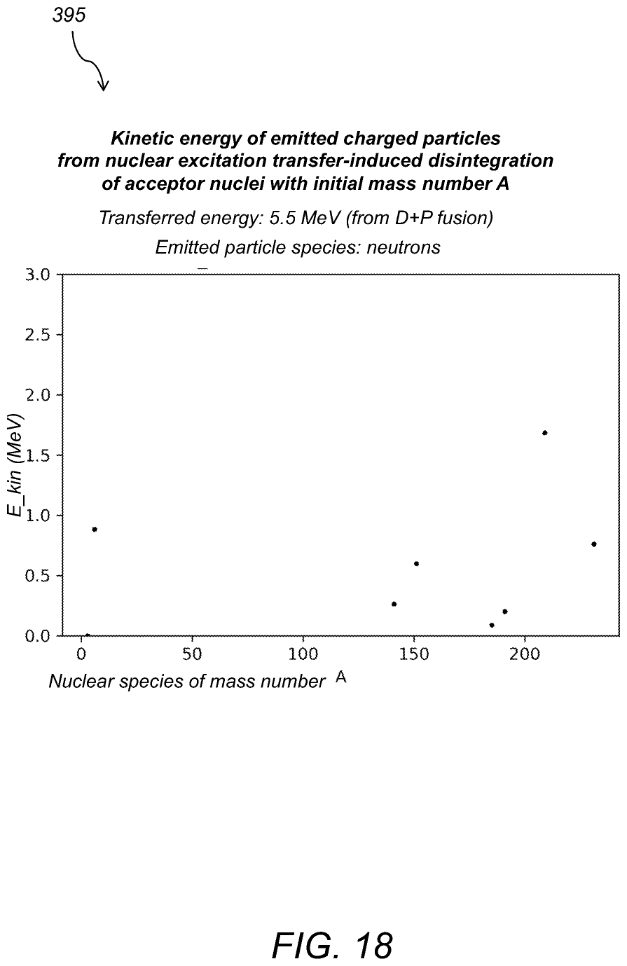

In general terms, FIG. 14 (alphas) and FIG. 15 (neutrons) provide an overview of secondary reaction products resulting from the transfer of released binding energy from H-2+H-2→He-4 reactions to acceptor nuclei of nuclear species with nuclear mass number A. Shown are the expected energy levels of the emitted particles if the respective material is embedded in the lattice as acceptor nuclei and the lattice sustains the coupled quantum system with the phonon-nuclear coupling strength sufficiently large to make incoherent excitation transfer the fastest and thus preferred channel of energy transfer (see below for a discussion of phonon-nuclear coupling strengths and implementations). FIG. 16 (alphas), FIG. 17 (neutrons), and FIG. 18 (protons) show an analog overview for potential secondary reaction products (i.e. energetic particles with respective kinetic energies) from the transfer of nuclear binding energy released from H-1+H-2→He-3 reactions to acceptor nuclei in the system's lattice with nuclear mass number A. These graphs inform the choice of materials to be used in the lattice configuration of nuclear excitation transfer-based particle production systems. A detailed description of the system design process and selection criteria for energetic particle production systems with desired energetic particle output energies is provided in section 4.8 below.

### 3.3. Coherent Fission and Transmutation Toward Lighter Nuclides

Disintegration reactions described above (such as Li-7→H-3 and He-4) can be viewed as asymmetric fission reactions or as transmutation toward lighter nuclides, since the process leads to a change of the nuclear species of the nuclei that undergo these reactions. Such disintegration/fission reactions are unlikely to be symmetric or close-to-symmetric when heavier nuclides are involved—the energy transferred from the primary nuclear reaction to the acceptor nucleus of a heavier nuclear species is unlikely to be high enough to reach the typically comparatively high energy levels in such acceptor nuclei that lead to symmetric or close-to-symmetric fission (on the order of tens of MeV). Academic literature describes the fission of nuclei in high energy rotational states and the different types of fission that follow from them. Specifically, rotational states leading to fission can be described as:

$${E}_{r o t} = \frac{{ℏ}^{2}}{2 ℐ} [ I ( I + 1 ) - {I}_{min} ( {I}_{min} + 1 ) ] , lowest I , {I}_{min} > 1 / 2$$

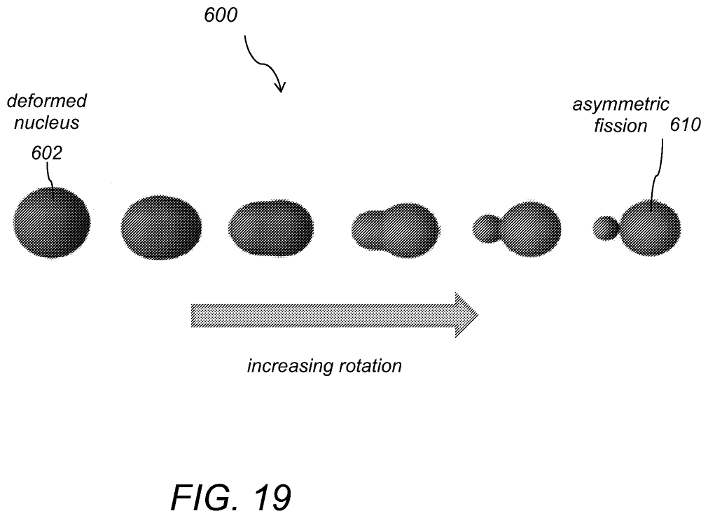

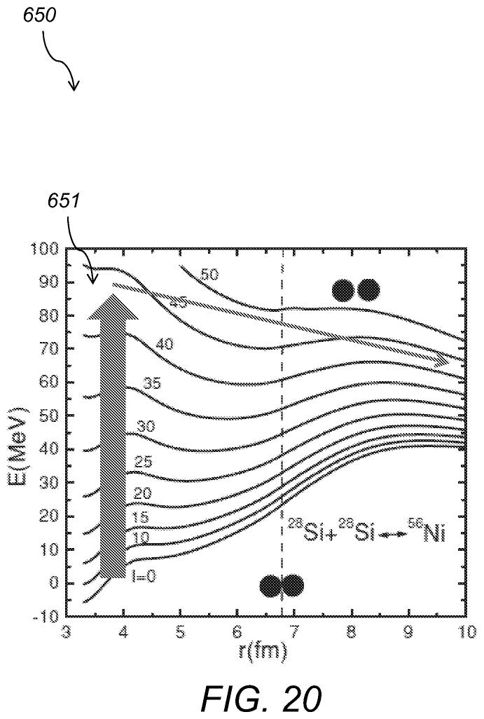

FIG. 19 illustrates in principle the process 600 from a deformed nucleus 610 to a splitting nucleus 610 through increased rotation (i.e. through occupation of high energy rotational states). A “ladder” of such rotational states is illustrated in FIG. 20 where the arrow 651 represents the occupation of higher and higher rotational states, essentially by spinning up the concerned nucleus. If symmetric or close-to-symmetric fission is the objective, then higher states on such a ladder of rotational states are to be occupied, and consequently larger quanta of energy to be transferred to such nuclei.

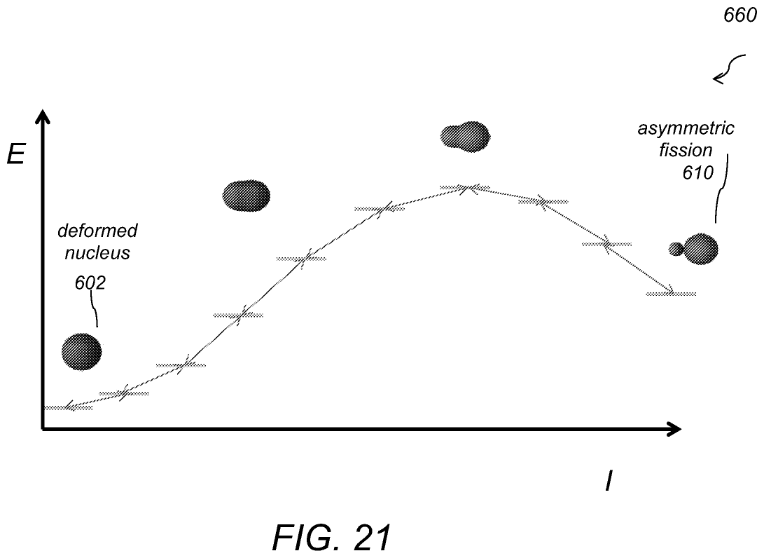

Energy transferred from other nuclei via incoherent nuclear excitation transfer is typically not sufficiently large to reach higher rotational states on such a ladder of rotational states. However, coherent nuclear excitation transfer offers the possibility to accumulate and transfer energy quanta of sufficient magnitude: coherent nuclear excitation transfer is excitation transfer where coherence is maintained over a long enough period of time, and phonon-nuclear coupling strength is sufficiently strong, for off-resonant states of high energy (tens of MeV) to be occupied. When respective energy quanta in off-resonant states are sufficiently large, they can transfer to an acceptor nucleus and occupy one of said rotational states, leading to fission. This approach is to be pursued if symmetric fission or close-to-symmetric fission of heavier nuclides is the design objective. FIG. 21 illustrates qualitatively the relationship between E and I in the course of coherent fission across the stages from a deformed nucleus 602 to a nucleus undergoing fission 610.

Comparatively strong phonon-nuclear coupling is needed for achieving such coherent nuclear excitation transfer (if the respective phonon-nuclear coupling is comparatively weaker, then the occupation of lower states of acceptor nuclei is to be expected instead—which leads to disintegration and comparatively more asymmetric fission products rather than the comparatively more symmetric fission products resulting from the occupation of higher rotational states.

Because symmetric fission and close-to-symmetric fission reactions through coherent nuclear excitation transfer presuppose strong phonon-nuclear coupling strengths, it is possible for the released nuclear binding energy to not get emitted incoherently but instead coherently down-convert and transfer to further excite phonon modes. For further descriptions on how to design lattice configurations with strong phonon-nuclear coupling strengths, refer to section 4 in this document.

Compared to the limited transmutation toward lighter nuclides through charged particle and neutron emission (i.e. where the reduction of the number of nucleons in the affected nuclei by the reaction is small), coherent fission offers the potential for larger downward steps in such transmutation toward lighter nuclides.

### 3.4. Transmutation Toward Heavier Nuclides

Nuclear excitation transfer also allows for transmutation toward heavier nuclides if a strong phonon-nuclear coupling is provided. In such cases, off-resonant states of high enough energy can be occupied such that the corresponding transfer of energy—equivalent to the mass-energy of one or multiple neutrons—leads to the elimination of a neutron in the donor nucleus and the formation of a neutron in the acceptor nucleus, a process that can be described as coherent neutron transfer. Coherent neutron transfer, induced by phonon-mediated nuclear excitation transfer with high phonon-nuclear coupling strength, can thus lead to the creation of nuclei of heavier nuclear species than the original acceptor nuclei.

### 4. Implementation

### 4.1. Exemplary Embodiments

The descriptions in this document are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each schematic drawing, at least one embodiment is made according to the apparent relative scale of the drawing.

### 4.1.1. Exemplary Embodiment 1

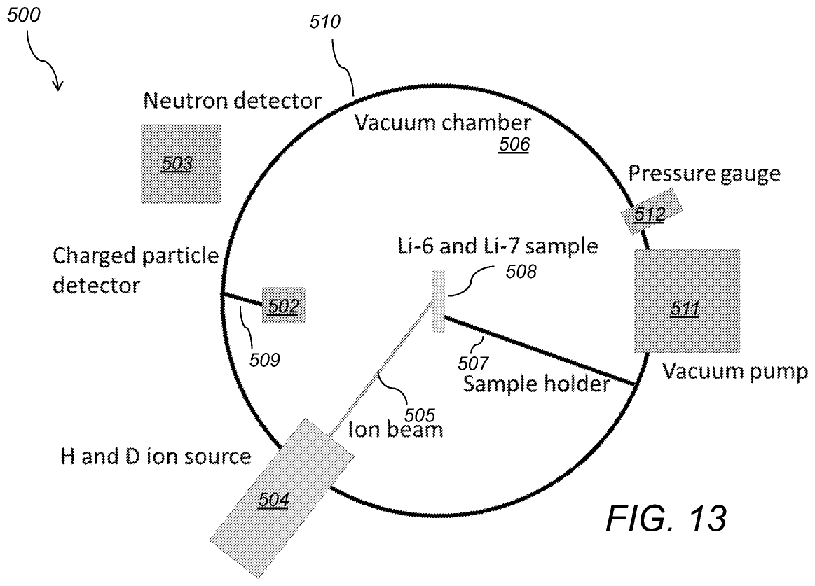

An exemplary embodiment for a system that exhibits the change of nuclear reaction products through nuclear excitation transfer-induced secondary reactions is described in more detail below and is illustrated in FIG. 13.

This exemplary system 500, includes a sample assembly 510, a particle detector 502 and a H and D ion beam 505 generated by an ion source 504. Sample assembly 510 includes a vacuum chamber 506 and sample 508 supported on a sample holder 507 within the vacuum chamber 506.

In one example, the vacuum chamber 506 is a spherical vacuum chamber such as the 18-inch outer diameter Lesker SP1800SEP vacuum chamber made of stainless steel and offering multiple flanged ports. In the vacuum chamber 506, at sufficiently low pressure to allow for the operation of an ion source, an ion beam 505 comprising hydrogen (H-1) and deuterium (H-2) nuclei is directed at a metal foil sample 508. A suitable vacuum chamber operating pressure is 10\hat{ }-7 torr with the ion beam turned off and up to 10\hat{ }-5 with the ion beam turned on. The operating pressure is monitored via a vacuum pressure gauge 512 mounted in a port of the vacuum chamber 506. The vacuum is pulled by a vacuum pump 511 such as the nEXT 400 turbomolecular pump from Edwards.

In one example, the sample holder 507 is a stainless-steel rod with an attached 50×50×5 mm plate whereas the sample holder is mounted on the inside of the vacuum chamber 506 to one of the chamber's ports and extends into the center of the chamber such as to allow for an attached sample to be positioned at the geometric center of the chamber 506. In one example, sample 508 includes a metal foil comprising Li-6 and Li-7 nuclei (natural lithium), measuring 50×50×0.1 mm. The sample is attached to the sample holder plate by metal clips via mechanical pressure.

The system is constructed and operated such that the ion beam 505 reaches the metal foil target 508 at energies ranging from 500-1000 eV. A suitable ion beam generator 504 is the DC25 ion source from Oxford Applied Research which is commonly used for parallel beam etching, assisted deposition, and sputtering application across the 10 eV-1000 eV range. In one example, the ion source is operated at a beam current of 0.1 mA. In another example, the beam current is varied in the range of 0.01 mA to 10 mA in order to maximize the desired effects (as described below). The ion source 504 is mounted in a port of the vacuum chamber via the NW63CF accessory mounting flange from Oxford Applied Research, pointing at the sample 508 on the sample holder 507 at the geometric center of the vacuum sphere. The sample is positioned at such an angle that the surface of the metal foil sample 508 and the ion beam 505 form a 45-degree angle. The beam diameter of the DC25's ion beam is 25 mm at 100 mm in-vacuum length. In one example, the ion source 504 is operated with a mixture of 50% hydrogen gas and 50% deuterium gas. In another example, the ion source is operated with a gas ratio of 100% deuterium gas. In another example, the gas ratio is adjusted stepwise from 100% hydrogen gas and 0% deuterium gas to 0% hydrogen gas and 100% deuterium gas in order to maximize the desired effects (as described below).

Charged particles emitted during operation of the system are detected with a silicon-based surface-barrier charged particle detector 502 such as an R-series detector from Ortec. In one example, an Ortec R-series detector with 600 mm\hat{ }2 detector size gets mounted on a stainless-steel detector holder 509 which securely mounts the detector 502 inside the vacuum chamber 506 via a holder rod similar to the sample holder 507. The detector holder 509 is attached to the vacuum chamber via a mount on the inside of a port flange. The detector 502 faces the sample 508 on the sample holder 507 in the geometric center of the vacuum chamber. In one example, the detector 502 position in the vacuum chamber 506 is such that it is separated from the ion source 504 on the circumference of the vacuum chamber 506 by an arc of 45 degrees in one spherical direction and 0 degrees in the other spherical direction. Since the sample metal foil 508 is oriented at a 45-degree angle to the ion beam 504 (see description above), the surface of the detector 502 and the surface of the metal foil sample 508 are parallel in this configuration. In one example, the distance between the surface of the detector 502 and the surface of the sample 508 is 50 mm. In another example, the position of the detector 502 is varied in order to maximize observations of the desired effects (as described below). The detector 502 is connected via an electrical feedthrough in a chamber port to an Ortec 142 preamplifier located outside of the vacuum chamber 506, and subsequently to an Ortec 672 spectroscopy amplifier as well as an Ortec 428 bias power supply. The spectroscopy amplifier output is digitized and binned via an Ortec EASY-MCA 8k multichannel analyzer which is connected via USB to a Windows computer where the Ortec Maestro software displays and records charged particle spectra with an accumulation of counts across one minute per spectrum. The one-minute spectra are then further accumulated across longer time periods in post-processing. In one example, all one-minute spectra across a 12-hour period during which the system is operated are summed up to form a cumulative spectrum. The gain of the spectroscopy amplifier is set such that a range from 1 MeV to 20 MeV of charged particle emission can be monitored during operation of the system. The detection subsystem can be calibrated using an Am-241 calibration source (available from Eckert & Ziegler) which emits alpha particles around 5.4 MeV. In one example, additionally a neutron detector 503 such as the FHT 762 Wendi-2 Wide-Energy Neutron Detector from Thermo Scientific is placed next to the vacuum chamber 506 (outside the chamber) within a 50 cm distance of the chamber.

As the ion source 504 is operated and bombards the sample 508 with hydrogen and deuterium nuclei, some of those nuclei get implanted in the metal foil. As the result of the implantation and subsequent bombardment with energetic ions, some of the incoming H-2 and H-1 projectiles fuse with some of the H-2 and H-1 ions implanted in the metal foil lattice in accordance with respective low-energy fusion reaction cross sections. Additionally, the ion beam bombardment generates high-frequency phonons in the lattice of the metal foil 508—including phonons in the THz regime —, thus locally increasing phonon-nuclear coupling strengths and facilitating nuclear excitation transfer i.e. the transfer of released nuclear binding energy from nuclei where this energy release originates to other nuclei in the surrounding lattice.

In regions of the metal foil sample 508 where the phonon-nuclear coupling strength is sufficiently high, the binding energy released from the fusion reaction transfers via phonon-mediated nuclear excitation transfer to Li-6 and Li-7 nuclei in the lattice of the metal foil. The subsequent decay of excited state Li-6 and Li-7 nuclei leads to nuclear reaction products as conventionally expected from the decay of these nuclear species from their respective temporary excitation and is measured with the charged particle detector 502 and the neutron detector 503. Consequently, this exemplary embodiment describes a system where a primary nuclear reaction (the hydrogen fusion reaction) leads to reaction products from a secondary nuclear reaction (the disintegration of excited Li-6 and Li-7)—while reducing or suppressing the conventionally expected reaction products from the primary nuclear reaction.

More generally speaking, in this exemplary embodiment, phonon-mediated nuclear excitation transfer leads to a change of nuclear reaction products (from a first nuclear reaction [energetic particles with a first energy] to reaction products of a second nuclear reaction/disintegration [energetic particles with a second energy]).

In other exemplary embodiments, the sample includes nuclei of one or several of the following elements and their isotopes: H, Li, Be, B, C, N, 0, Na, Mg, Al, Si, P, S, Cl, K, Ca, Sc, Ti, V, Cr, Mn, Fe, Co, Ni, Cu, Zn, Ga, Ge, As, Se, Br, Rb, Sr, Y, Zr, Nb, Mo, Tc, Ru, Rh, Pd, Ag, Cd, In, Sn, Sb, Te, I, Cs, Ba, La, Ce, Pr, Nd, Pm, Sm, Eu, Gd, Tb, Dy, Ho, Er, Tm, Yb, Lu, Hf, Ta, W, Re, Os, Ir, Pt, Au, Hg, Tl, Pb, Bi, Po, At, Fr, Ra, Ac, Th, Pa, U, Np, Pu, Am, Cm, Bk, Cf, Es, Fm.

### 4.1.2. Exemplary Embodiment 2

An alternative exemplary embodiment for a system that exhibits the change of nuclear reaction products and related effects through phonon-mediated nuclear excitation transfer is described in more detail below and shown in FIG. 8. In this example, the primary nuclear reaction (also described as first nuclear reaction) is beta decay of a radioactive isotope. Absent the operation of a system for changing nuclear reaction products and related effects such as the one described below, the result of this beta decay reaction is the subsequent isotropic photon emission from the site of the decaying nuclei. The system described below changes the result of this reaction to anisotropic photon emission and photon emission from other nuclei that are different from the decaying nuclei (i.e. nuclei on other sites in the lattice). See FIGS. 4-7 for an illustration of this mechanism in a form that is reduced to key aspects to emphasize the general principle (described in more detail in section 3.1. above).

Referring to FIG. 8, a system for photon generation 400 includes a sample assembly 410, an energy dispersive x-ray camera 402 with a pinhole optic 409 and a tunable Terahertz (THz) laser 404. Sample assembly 410 includes a vacuum chamber 406 and sample 408 supported on a sample holder 407 within the vacuum chamber 406. Sample 408 includes a metal foil comprising radioactive Co-57, Fe-56, Fe-57 nuclei and excited Fe-57* nuclei (the latter resulting from the decaying Co-57 nuclei). Laser 404 emits a laser beam 405 that is directed onto sample 408. Laser beam 405 provides a source of phonons that contribute to the phonon-induced nuclear energy transfer.

The vacuum chamber setup, including vacuum chamber 406, vacuum pump 411 and vacuum gauge 412, is identical to the one described in the exemplary embodiment 1 in the section above and is operated at a vacuum pressure of 10\hat{ }-3 torr.

The sample assembly 410 includes a sample 408 in the form of a plate. In one example, the sample 408 is an elongated plate and has dimensions of 3″×6″× 5/32″. In one example, sample 408 is a steel plate made of rolled low-carbon steel (McMaster-Carr part number 1388K546). In one example, sample 408 is a plate made of natural iron. In one example, at the geometric center of the plate sample surface, a radioactive substrate is placed. Placing the radioactive substrate on the plate is carried out during the preparation of the sample subsystem outside the vacuum chamber i.e. before the sample is subsequently mounted on the sample holder and a vacuum is pulled. Specifically, a 0.05 ml drop of a 57CoCl2 in 0.1 M HCl solution (from Eckert & Ziegler) is used with an activity of approximately 250 μCi. The drop of solution is left to evaporate over the course of one hour and forms a grey ring with a diameter of approximately 12 mm on the surface of the steel plate. The sample assembly now includes a ring-shaped substrate of evaporated 57CoCl2 solution bonded to the underlying plate. The substrate comprises a declining number of radioactive Co-57 nuclei which act as a source of nuclear excitation. The substrate also provides a steady, short-lived presence of excited Fe-57* nuclei resulting from decaying Co-57 nuclei as well as Fe-57 nuclei in ground state from earlier Co-57 decay. Additional ground state Fe-57 nuclei are present in the underlying plate due to the natural occurrence of Fe-57 in iron.

In one example, the sample 408 is a plate made of an alloy that includes Fe-57 and Co-57 nuclei. In one example, the sample is made such that one region of the sample, such as the left half, has a high concentration of Fe-57 nuclei (higher than thrice the number of Co-57 nuclei in that region) and another adjacent region of the sample, such as the right half, has a high concentration of Co-57 nuclei (higher than thrice the number of Fe-57 nuclei in that region).

In one example, the sample holder 407 is a stainless-steel rod whereas the sample holder is mounted on the inside of the vacuum chamber 406 to one of the chamber's ports and extends into the center of the chamber such as to allow for an attached sample to be positioned at the geometric center of the vacuum chamber 406. In one example, the sample is attached to the sample holder plate by metal clips via mechanical pressure.

The laser 404 is a quantum-cascade laser with a tunable frequency range above 1 and below 15 Thz. The laser power is above 1 mW. The laser 404 is mounted in a port of the vacuum chamber 406 such that it points at the center of the sample 408 held by the sample holder 407 and generates phonons in the sample lattice at set frequencies during the operation of the system. In one example, the laser is mounted outside the vacuum chamber and the laser beam enters the vacuum chamber through a window.

An energy dispersive x-ray camera 402 is mounted in one port of the vacuum chamber 406, facing the center of the vacuum chamber. In one example, the x-ray camera 402 is an iKon M camera from Andor with a resolution of 1024×1024 pixel and a 25 um Beryllium window.

The sample 408 is positioned such that the surface of the sample 408 is parallel to the surface of the window of the camera 402. The distance between the camera window surface and the sample surface is 50 mm with a lead (Pb) pinhole optic 409 positioned half-way between the camera 402 and the sample 408. The lead pinhole optic 409 consists of a 50×50×1 mm lead plate with a 0.5 mm hole at the center whereas the hole is punched into the plate from both sides of the plate with two conically formed awls pressing through the plate at its geometric center halfway from each side. The camera 402, the pinhole in the pinhole optic 409 and the sample 408 are aligned along an axis perpendicular to the camera window surface and the sample surface such that the center of the camera sensor (behind the camera window) aligns with the center of the pinhole and the center of sample surface. In this configuration, the laser 404 is angled such that the laser beam 405 hits the geometric center of the surface of the sample 408.

During operation of the system, the laser 404 is activated, thus generating phonons in the lattice of the sample, and the x-ray camera 402 is used to continuously record x-ray images of the photon emission from the sample. In one example, the x-ray camera 402 is operated at its fastest readout rate in order to obtain spectral (i.e. energy) information on each pixel thus allowing for the generation of separate images for separate photon energy bands. In one example, the laser 404 is operated by scanning stepwise through the tunable frequency range of the laser. In this configuration, step changes in the laser frequency are carried out once per 12 hours. In between step changes, the laser is operated at fixed frequency. During the operation of the laser 404, the x-ray camera 402 records emission from the sample with spatial and temporal (and in some examples energy) resolution. Exposure of the camera is continuous (to the extent that the camera specifications allow). Image data from the camera is read out and stored once per minute and are summed up over longer periods of time such as a 12-hour-period to form long-exposure images. Such image data of the sample emission is also obtained before and after the operation of the laser. The image data represents the spatial and angular distribution of photon emission from the sample 408.

When comparing images before operation, across different frequencies (laser frequencies i.e. corresponding to phonon frequencies in the lattice) during operation, and after operation, the x-ray images exhibit changes with respect to the spatial and angular distribution of photon emission caused by phonon-mediated nuclear excitation transfer.

Changes in the angular distribution of emission are caused by resonant excitation transfer of nuclear excitation that leads to nuclear phase coherence of affected nuclei and thus collimation of respective photon emission from those nuclei. Changes in the spatial distribution of emission are caused by non-resonant excitation transfer of nuclear excitation where nuclear excitation energy transfers a number of times from nuclei to nuclei—in some cases across a macroscopic distance—until a photon emission occurs at the final acceptor nuclei (at a distance from the nucleus where the nuclear energy release from beta decay initially occurred).

More generally speaking, in this exemplary embodiment, phonon-mediated nuclear excitation transfer leads to a change of nuclear reaction products (from isotropic photon emission from the sites of Co-57 nuclei to anisotropic photon emission from the sites of other nuclei).

In other exemplary embodiments, the sample includes nuclei of one or several of the following elements and their isotopes: H, Li, Be, B, C, N, 0, Na, Mg, Al, Si, P, S, Cl, K, Ca, Sc, Ti, V, Cr, Mn, Fe, Co, Ni, Cu, Zn, Ga, Ge, As, Se, Br, Rb, Sr, Y, Zr, Nb, Mo, Tc, Ru, Rh, Pd, Ag, Cd, In, Sn, Sb, Te, I, Cs, Ba, La, Ce, Pr, Nd, Pm, Sm, Eu, Gd, Tb, Dy, Ho, Er, Tm, Yb, Lu, Hf, Ta, W, Re, Os, Ir, Pt, Au, Hg, Tl, Pb, Bi, Po, At, Fr, Ra, Ac, Th, Pa, U, Np, Pu, Am, Cm, Bk, Cf, Es, Fm.

### 4.2. Phonon-Nuclear Coupling Strength Parameters

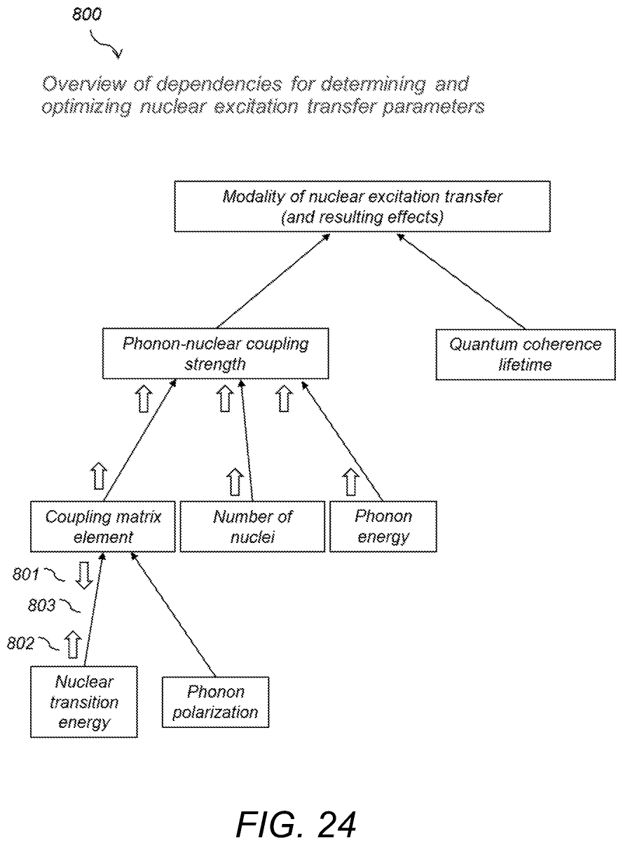

As the descriptions above exhibit, which modalities of nuclear excitation transfer manifest in a given configuration (such as incoherent nuclear excitation transfer, resonant nuclear excitation transfer, non-resonant nuclear excitation transfer) and therefore which effects manifest (such as changes in photon emission, disintegration of nuclei and charged particle emission) and which applications can therefore be implemented in a given system critically depends on the phonon-nuclear coupling strengths in that system as well as the amount of time during which coherence of the coupled quantum system within which energy transfer takes place is maintained. Phonon-nuclear coupling strengths grow alongside the following parameters: the number of phonon modes interacting with the nuclei; the energy in the phonon modes interacting with nuclei (depending on phonon frequencies and amplitudes); the number of nuclei participating in the respective coupled quantum system; and inversely the nuclear transition energies of the nuclei participating in the coupled quantum system. Phonon-nuclear coupling strengths also depend on (grow with) the characteristic coupling matrix elements that describes the coupling between initial states and final states for the nuclear transitions of the nuclei involved in the respective excitation transfer. These dependencies are illustrated in FIG. 24: nuclear transition energy and phonon polarization impact the magnitude of the coupling matrix element which, together with the number of nuclei in the coupled quantum system and phonon energy impacts the respective phonon-nuclear coupling strength. In FIG. 24, the solid arrows represent a dependency and the non-solid arrows indicate how the dependent and independent variables in a dependency pair (i.e. two blocks between a solid arrow) are correlated. In the case of the relationship 803 between nuclear transition energy and the respective coupling matrix element impacted by it, as represented by the solid arrow 803, the upward facing non-solid arrow 802 and the downward facing non-solid arrow 801 describe that higher nuclear transition energy translates to a smaller coupling matrix element, when all other factors are held fixed.

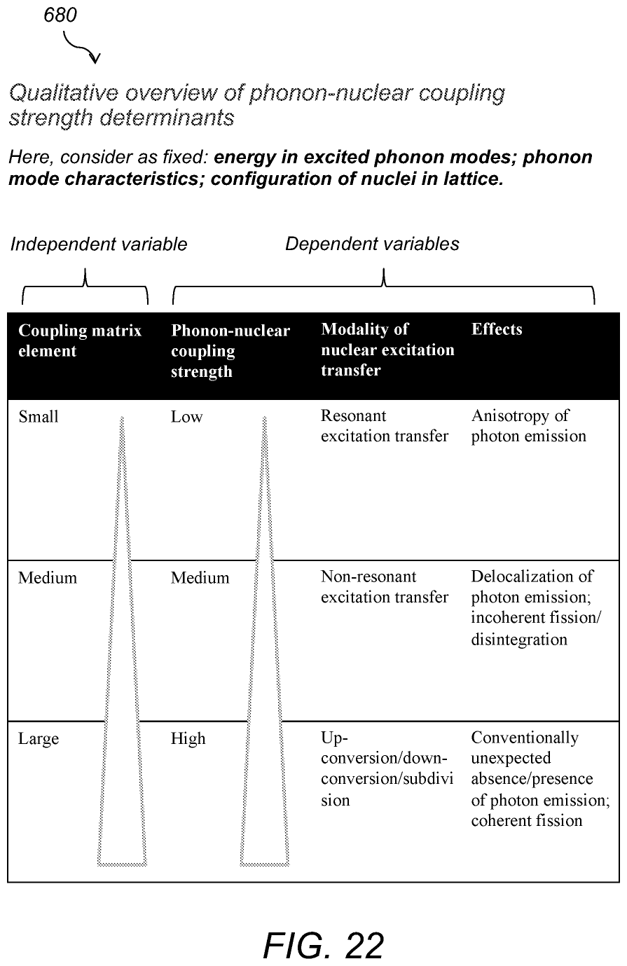

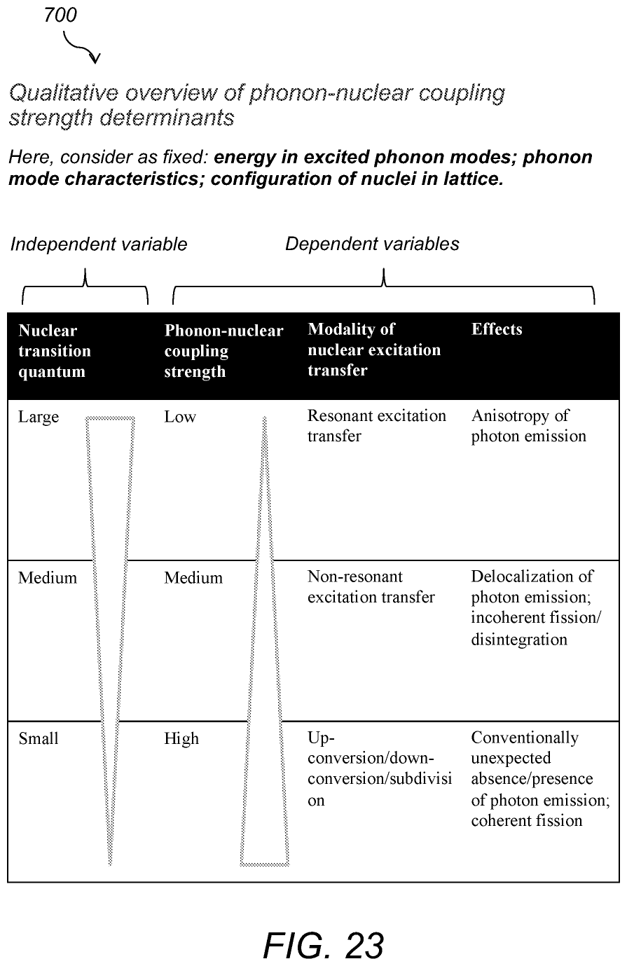

Important qualitative dependencies of key factors entering system design decisions such as nuclear transition energies and coupling matrix elements and are illustrated in FIG. 22 and FIG. 23. In these two figures, the energy in excited phonon modes, the phonon mode characteristics, and the lattice configuration are considered fixed. Given this backdrop, the table in FIG. 22 illustrates qualitatively how a relative change in the coupling matrix element magnitude impacts the corresponding phonon-nuclear coupling strength, nuclear excitation transfer modalities, and related effects. Similarly, the table in FIG. 23 illustrates qualitatively how a relative change in the nuclear transition quantum of a nucleus (i.e. when comparing different nuclear species with different nuclear transition energies to each other) impacts phonon-nuclear coupling strength, nuclear excitation transfer modalities, and related effects.

An approach for quantitative estimates of respective parameters through simulations is described further below. For further details on phonon-nuclear coupling strength characteristics, refer to Dr. Hagelstein's 2018 paper on “Phonon-Mediated Nuclear Excitation Transfer” (Hagelstein 2018) and Dr. Metzler's 2019 thesis “Experiments to Investigate Phonon-Nuclear Interactions” (Metzler 2019—thesis in the MIT Nuclear Science & Engineering Department available on MIT Dspace), both of which are hereby included by reference in their entirety.

### 4.3. Mapping Phonon-Nuclear Coupling Strengths to Applications

If phonon-nuclear coupling strength is comparatively weak, resonant nuclear excitation transfer can be expected i.e. no energy is exchanged with the lattice between initial and final states. In other words: during resonant nuclear excitation transfer, phonons only mediate energy transfer but do not directly emit or absorb additional energy in the system. In terms of applications, this form of nuclear excitation transfer causes angular anisotropy as acceptor nuclei exhibit nuclear phase coherence. If the phonon-nuclear coupling strength is stronger, non-resonant excitation transfer can occur i.e. in addition to state changes between initial and final states, energy in the system can get absorbed or emitted by one or more phonon modes. In terms of applications, non-resonant excitation transfer can manifest as delocalization of emission, and the triggering of secondary nuclear reactions/decays, as described above in the section on incoherent excitation transfer. Even stronger phonon-nuclear coupling strength enable coherent excitation transfer, as energy accumulates in off-resonant states which can eventually transfer to comparatively high energy nuclear states in the acceptor nuclei such as rotational high energy states. In terms of applications, this enables coherent fission and neutron transfer. Another application enabled by strong phonon-nuclear coupling strength with the potential to affect high energy nuclear states is temporary energy storage in metastable states.

### 4.4. Determining Coupling Matrix Elements

The magnitude of the characteristic phonon-nuclear coupling matrix elements for different materials is relevant for determining the range of achievable phonon-nuclear coupling strengths in given lattice configurations. The latter in turn determines the feasible modes of nuclear excitation transfer, and thus the range of application modes that can be implemented in the given system. The coupling matrix element for different materials can be determined from first principles calculations, or empirically through measurements, or a combination thereof.

The experiments and measurements described in PCT/US2018/35883 and in Metzler 2019 were critical in the exploration of nuclear excitation transfer, as they provided empirical evidence of the phenomenon and allowed for the first estimation of a coupling matrix element. These experiments led to a first estimation of the coupling matrix element for an excited state Fe-57* nucleus embedded in a local BCC lattice of ground state Fe-57 nuclei. Based on the experimental results, we estimate the corresponding phonon-nuclear coupling matrix element in the configuration on the order of: V=1.6×10\hat{ }-8 eV.

Detailed steps for first-principle calculations of phonon-nuclear coupling matrix elements based on nuclear structure models are described in Hagelstein 2018.

### 4.5. Modelling and Engineering Phonon Characteristics

Phonon modes and expected phonon energies in given system configurations, such as in specific lattice configurations (i.e. the arrangement of nuclei in the lattice), and based on different forms of phonon generation can be modeled and simulated by using standard computational tools of condensed matter physics (including, for instance, the Quantum Espresso collection of codes). Creating nanostructures with particular phonon characteristics such as specific phonon modes and energies is described by publications in the field of phonon engineering whose insights are applied to the design of nuclear excitation transfer-based systems.

Furthermore, if specific nuclear reactions are used (e.g. as primary reactions providing a first energy) in a particular embodiment (i.e. in the lattice or amorphic structure of such an embodiment) such as, for instance, hydrogen fusion reactions in a Pd or Ni lattice, then the system designer also needs to consider the creation of vacancies in the lattice in order to enable site occupation of hydrogen nuclei in the respective lattice that allow for proximity of such nuclei (and thus increase of tunneling probabilities and fusion cross sections). Vacancies can be created in a lattice in a number of known ways, including via ion implantation and electrochemical co-deposition.

### 4.6. Stepping Stones for Up-Stepping and Down-Stepping; Avoidance of Lattice Disintegration

As has been discussed above, if phonon-nuclear coupling is strong enough, non-resonant excitation transfer enables the transfer of nuclear excitation energy to excited phonon modes (i.e. vibrational modes of the lattice) and vice versa. However, if the energy thus absorbed by vibrational modes of the lattice is large enough to break the bonds between lattice atoms, then the lattice can disintegrate as a result of energy accepted via nuclear excitation transfer.

In most applications, this outcome is undesired as it represents a partial destruction of the system. To avoid lattice disintegration, intermediate acceptors of subdivided nuclear excitation can be included in the lattice configuration. These intermediate acceptor nuclei can then accept excitation from donor nuclei and emit this energy either incoherently (e.g. through energetic particle emission at lower energy) or coherently by transferring the energy to phonon modes—from an applications perspective, either the former or the latter outcome may be preferred, depending on the specific design objectives (e.g. charged particles may be preferred over heat if direct electric conversion is to be employed). The intermediate acceptor nuclei that enable this “down-stepping” of energy quanta allow for the transfer of received energy to a wider range of nuclei in the lattice (i.e. a reduction of concentration of this energy), thereby reducing the possibility of a section of the lattice disintegrating from the absorption of a quantum of energy that would otherwise break respective atomic bonds on a large scale. Particularly suitable as “stepping stone” intermediate acceptors are such nuclei as Hg-201.

The concept of intermediate “stepping stones” and step-wise up- and down-conversion to and from large energy quanta goes beyond just avoiding lattice integration. “Stepping stone” nuclei also facilitate up-conversion such as when reaching for higher energy states e.g. in the process of inducing coherent fission (see section on coherent fission above). “Stepping stone” nuclei can also be used to change preferred transfer and conversion channels in a given system and thus facilitate desired energy flows.

### 4.7. Ramping Up Phonon-Nuclear Coupling Strength and Phonon Energy

As has been described, preferred transfer and conversion channels and associated energy flows are impacted by the configuration of the lattice structure (lattice configuration) and the corresponding phonon-nuclear coupling strengths in the system.

Higher phonon energy levels lead to higher phonon-nuclear coupling strengths. In turn, high phonon-nuclear coupling strengths lead to conditions where nuclear excitation energy (e.g. from released nuclear binding energy) can transfer coherently to phonon modes and further increase phonon energy levels. This in turn increases phonon-nuclear coupling strengths which can lead to more coherent nuclear excitation transfer and associated increases in phonon energy and so on. This principle forms the basis of an application mode of a nuclear excitation transfer-based system that effectively represents a phonon laser i.e. a process in which a positive feedback loop leads to a stepwise increase of phonon energy in the system.

The above implies that some phonon-mediated nuclear excitation transfer-based systems require an initial stimulus i.e. an initial increase in phonon energy before running self-sustaining due to a positive feedback loop. Such an initial stimulus to ramp up phonon-nuclear coupling strengths through increases in phonon energy can result from a number of different phonon generators including lasers, mechanical stress, ion beams, electrical pulses. A nuclear reaction such as a fusion reaction where the released nuclear binding energy coherently transfers to excited phonon modes also enables an increase in phonon energy. An increase in phonon energy (through either of the above-mentioned methods) can then increase the phonon-nuclear coupling strengths in the system which in turn can enable other modes of nuclear excitation transfer as well as associated secondary reactions.

### 4.8. Design Method for Charged Particle Generation Systems

Nuclei from different nuclear species, when placed in excited states such as through the acceptance of nuclear excitation via phonon-mediated nuclear excitation transfer, disintegrate with different resulting particle species and particle energies. Therefore, when designing a system for energetic particle generation, a system designer needs to consider the nuclear species of nuclei to be embedded in the system as acceptor nuclei (acceptors of energy transferred via phonon-mediated nuclear excitation transfer). In other words, different acceptor nuclei lead to different emitted particles and particle energies. Designing a system whose output products include energetic particles with kinetic energies within a specific energy band is useful for a range of applications such as in direct electric conversion.

In alternative embodiments, nuclei used in a lattice configuration as acceptor nuclei include of one or several of the following elements and their isotopes: H, Li, Be, B, C, N, O, Na, Mg, Al, Si, P, S, Cl, K, Ca, Sc, Ti, V, Cr, Mn, Fe, Co, Ni, Cu, Zn, Ga, Ge, As, Se, Br, Rb, Sr, Y, Zr, Nb, Mo, Tc, Ru, Rh, Pd, Ag, Cd, In, Sn, Sb, Te, I, Cs, Ba, La, Ce, Pr, Nd, Pm, Sm, Eu, Gd, Tb, Dy, Ho, Er, Tm, Yb, Lu, Hf, Ta, W, Re, Os, Ir, Pt, Au, Hg, Tl, Pb, Bi, Po, At, Fr, Ra, Ac, Th, Pa, U, Np, Pu, Am, Cm, Bk, Cf, Es, Fm.

If charged particles with kinetic energies within a specific energy band are desired, the system designer needs to consider the nuclear species whose disintegration via nuclear excitation transfer enabled excitation yield charged particles with kinetic energies in the desired energy range. FIGS. 14-18 provide an overview of the expected kinetic energies for energetic particles resulting from the disintegration of nuclei of nuclear species across the range of mass numbers A. In each graph in FIGS. 14-18, the y-axis describes the kinetic energy of the respective particle for the given primary nuclear reaction (see graph titles for this information); the x-axis describes the corresponding mass number A of nuclei that yield energetic particles with kinetic energy of the corresponding energy on the y-axis.

A system designer needs to select the desired energy range on the y-axis and identify the corresponding nuclear species of initial mass number A on the corresponding section on the x-axis.

If several suitable candidates are found, then secondary factors need to be considered such as the photodisintegration cross section of the candidate nuclei which determines the rate of transfer, and thus the efficiency of the system, as well as other parameters such as cost and chemical properties of the candidate nuclear species.

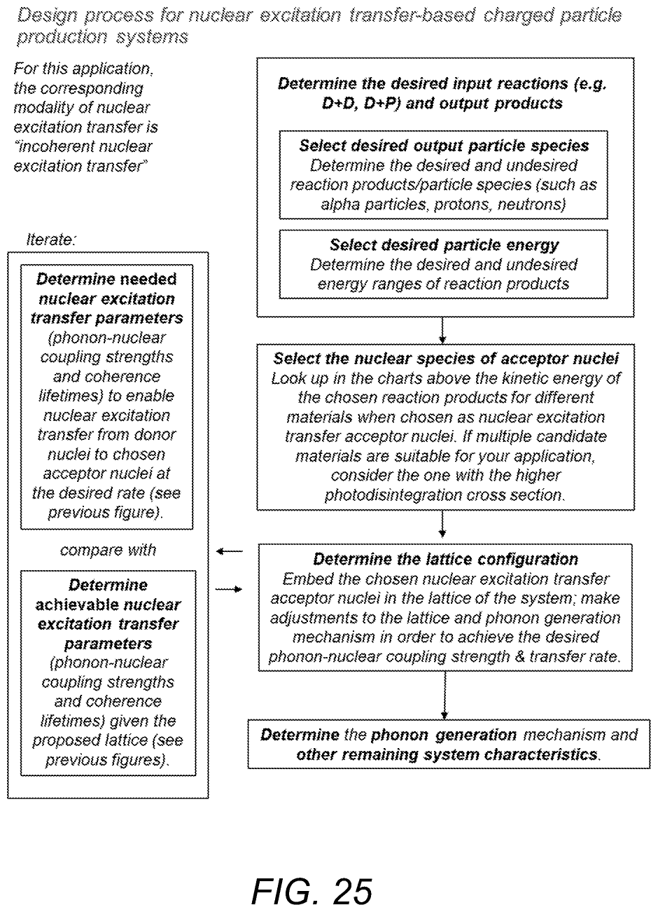

A summary of the system design process leading to the identification of nuclear species for desired charged particle energies, among other steps, is laid out in FIG. 25.

### 4.9. General Design Method

The above design process covers a specific case (charged particle generation of charged particles with specific kinetic energies) of a more general design process for the design of nuclear excitation transfer-based systems with a wider range of inputs, outputs, and functions.

As described in section 3, nuclear excitation transfer-based systems and the methods to design them allow for a wide range of applications and achievable design objectives. A practitioner will want to design a system based on a range of factors such as the availability of materials, their chemical properties, their cost, hazardousness, and manufacturability; the desired output products (such as charged particles, other energetic particles, heat, etc.); the required equipment to trigger and stimulate reactions. Other design constraints can further include size, reliability, efficiency, and robustness of the system.

The method and system presented here encompass a wide range of concrete embodiments which may be varied depending on the engineering and design objectives in a specific case and embodiment. Because of the wide range of manifestations and possible embodiments, not every embodiment is described in detail in this present document. Because of that, this section lays out a general-purpose design approach i.e. a process for the practitioner to reach specific design objectives which can span a wide parameter space of goals and constraints.

In alternative embodiments, nuclei used in a lattice configuration include one or several of the following elements and their isotopes: H, Li, Be, B, C, N, 0, Na, Mg, Al, Si, P, S, Cl, K, Ca, Sc, Ti, V, Cr, Mn, Fe, Co, Ni, Cu, Zn, Ga, Ge, As, Se, Br, Rb, Sr, Y, Zr, Nb, Mo, Tc, Ru, Rh, Pd, Ag, Cd, In, Sn, Sb, Te, I, Cs, Ba, La, Ce, Pr, Nd, Pm, Sm, Eu, Gd, Tb, Dy, Ho, Er, Tm, Yb, Lu, Hf, Ta, W, Re, Os, Ir, Pt, Au, Hg, Tl, Pb, Bi, Po, At, Fr, Ra, Ac, Th, Pa, U, Np, Pu, Am, Cm, Bk, Cf, Es, Fm.

The practitioner needs to consider and design the resulting embodiment accordingly:
1. What are the desired input reactions and what are the desired output products?
2. Which materials can be considered as acceptor nuclei to achieve the outcome defined in the previous question?
3. What other nuclei should be considered in the system structure/lattice configuration e.g. as stepping stones for up-stepping or down-stepping (see section 4.6.)?
4. Related to the answers of the previous questions, what magnitudes of corresponding phonon-nuclear coupling strengths are achievable for the materials involved within the engineering and design constraints (such as the potential constraints listed above)? What magnitudes of phonon-nuclear coupling strengths are needed in order to achieve the desired input reactions and output products?
5. Is incoherent nuclear excitation transfer sufficient or is coherent nuclear excitation transfer needed (if incoherent excitation transfer is sufficient, then it is typically preferred for its greater simplicity in implementation)?
6. What is the desired and what is the required lattice configuration of donor and acceptor nuclei? What is their ratio and distance?
7. What are the phonon modes of the lattice? Which phonon modes should be involved in the coupling and get excited? What is the desired and achievable phonon energy? How do design choices related to previous questions affect phonon characteristics?

By working iteratively through this catalog of questions and the disclosed system design process, a practitioner can set up a system structure and lattice configuration, an input reaction and a phonon generation mechanism that achieves the desired output products.

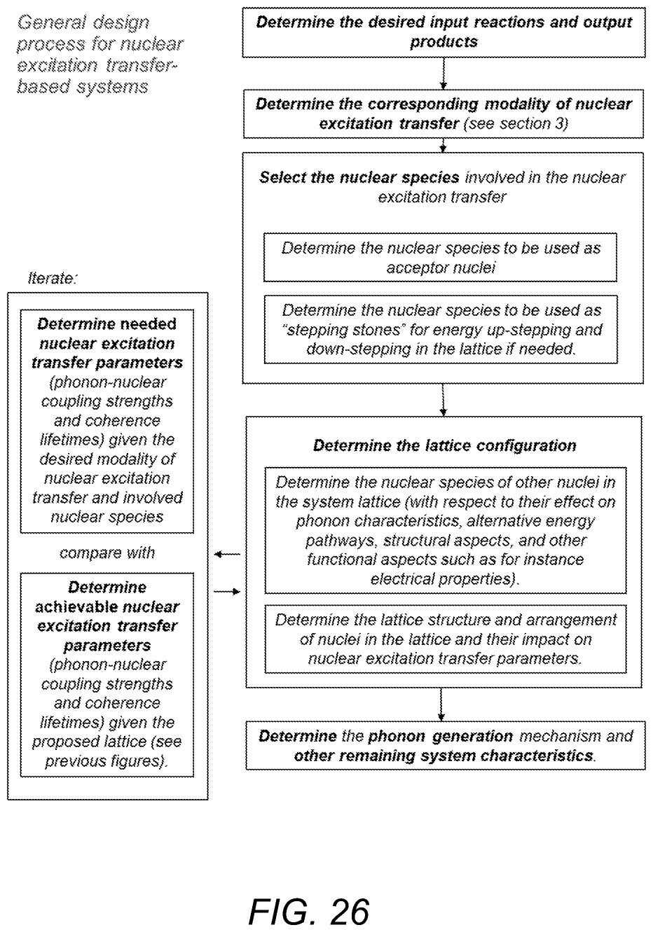

A summary of the general system design process leading to the desired system outcomes is laid out in FIG. 26.

### 4.10. Modelling-Based Determination of Phonon-Nuclear Coupling Strengths and Resulting Energy Transfer Channels

Simulations that consider condensed matter dynamics as well as coupling with nuclear states of different energies can aide in the identification and creation of specific lattice configurations that correspond to desired design objectives. Such simulations aide in the determination of phonon-nuclear coupling strengths and in the preferred energy transfer channels i.e. energy pathways in a given system that are preferred.

A starting point for simulations is the following model that describes a collection of nuclei and electrons as in an atomic lattice:

$$\hat{H} = {\sum }_{j} {M}_{j} {c}^{2} + {\sum }_{j} \frac{{\vert {P}_{j} \vert}^{2}}{2 {M}_{j}} + {\sum }_{k} \frac{{\vert {\hat{P}}_{k} \vert}^{2}}{2 {m}_{e}} + {\sum }_{j} {a}_{j} \cdot c {\hat{P}}_{j} - {\sum }_{j} {D}_{j} \cdot E ( {R}_{j} ) - {\sum }_{j} {μ}_{j} \cdot B ( {R}_{j} ) + \frac{{e}^{2}}{4 {πϵ}_{0}} ( {\sum }_{j < {j}^{′}} \frac{{Z}_{j} {Z}_{{j}^{′}}}{\vert {R}_{j} - {R}_{{j}^{′}} \vert} - {\sum }_{j , k} \frac{{Z}_{j}}{\vert {R}_{j} - {r}_{k} \vert} + {\sum }_{k < {k}^{′}} \frac{1}{\vert {r}_{k} - {r}_{{k}^{′}} \vert} ) \qquad ( 6 )$$

The matrix M in the first term includes the different internal nuclear state energies as diagonal elements. Shifts in nuclear state energies caused by changes in nucleon-nucleon binding energies during off-resonant state occupation are accounted for by the adjustment (countering otherwise present destructive interference effects):

Mⱼc²→Mⱼ(E)c²

The Hamiltonian above further includes Coulomb interaction terms between nuclei, between electrons, and between nuclei and electrons. Electric dipole and magnetic dipole interactions are included through the existing terms. The relativistic boost interaction that gives rise to phonon-nuclear coupling appears as an a*cP interaction. A such, this Hamiltonian represents an extension of analogous Hamiltonians used in solid state applications.

Separating electronic and nuclear parts leads to a simplification of the model. The resulting model is similar to models for interatomic potentials such as in embedded atom theory:

$$\hat{H} = {\sum }_{j} {M}_{j} {c}^{2} + {\sum }_{j} \frac{{\vert {\hat{P}}_{k} \vert}^{2}}{2 {M}_{j}} + {\sum }_{j < {j}^{′}} {V}_{{jj}^{′}} ( \vert {R}_{j} - {R}_{{j}^{′}} \vert ) + {\sum }_{j} {a}_{j} \cdot c {\hat{P}}_{j} - {\sum }_{j} {D}_{j} \cdot E ( {R}_{j} ) - {\sum }_{j} {μ}_{j} \cdot B ( {R}_{j} )$$

This model can be further reduced to focus on the interactions of phonon modes with internal nuclear transitions:

$$\hat{H} = {\sum }_{j} {M}_{j} {c}^{2} + {\sum }_{k , σ} {ℏω}_{k , σ} {\hat{a}}_{k , σ}^{†} {\hat{a}}_{k , σ} + {\sum }_{j} {\sum }_{k , σ} {a}_{j} \cdot c ( \frac{\partial {P}_{j}}{\partial {a}_{k , σ}^{†}} {\hat{a}}_{k , σ} + \frac{\partial {P}_{j}}{\partial {a}_{k , σ}^{†}} {\hat{a}}_{k , σ}^{†} )$$

The model above serves as a basis for first principle calculations of phonon-nuclear coupling strengths to further inform the specific configuration of lattice structures matched to the desired application modes and design objectives of phonon-mediated nuclear excitation transfer-based systems.

### 4.11. Variations in the Design of the Disclosed System

Other embodiments include one or more of the following. Specifically, the materials used as acceptor nuclei and in the lattice configuration of the system's phonon-carrying lattice or amorphous structure may be one or several of the following elements and their isotopes: H, Li, Be, B, C, N, 0, Na, Mg, Al, Si, P, S, Cl, K, Ca, Sc, Ti, V, Cr, Mn, Fe, Co, Ni, Cu, Zn, Ga, Ge, As, Se, Br, Rb, Sr, Y, Zr, Nb, Mo, Tc, Ru, Rh, Pd, Ag, Cd, In, Sn, Sb, Te, I, Cs, Ba, La, Ce, Pr, Nd, Pm, Sm, Eu, Gd, Tb, Dy, Ho, Er, Tm, Yb, Lu, Hf, Ta, W, Re, Os, Ir, Pt, Au, Hg, Tl, Pb, Bi, Po, At, Fr, Ra, Ac, Th, Pa, U, Np, Pu, Am, Cm, Bk, Cf, Es, Fm.

The arrangement of the nuclei in the lattice or amorphous structure includes configurations of nuclei in a lattice or amorphous structure where the lattice or amorphous structure can sustain phonons and allow for the coupling of the phonons to lattice nuclei. This includes lattice configurations with defects such as vacancies and dislocations.

The mechanism for phonon generation includes all methods for generating phonons, and specifically phonons of frequency >1 THz, in an atomic lattice or amorphic structure.

The mechanism for generating initial nuclear excitation (first energy) include all methods for exciting atomic including nuclear fusion, nuclear fission, alpha decay and beta decay, among others.

Several embodiments of the present invention have been described. Nevertheless, it will be understood that various modifications may be made without departing from the spirit and scope of the invention. Accordingly, other embodiments are within the scope of the following claims.

What is claimed is:

1. A system for generating energetic particles comprising:
a device for generating an ion beam comprising a first group of atomic nuclei;
a condensed matter medium comprising a second group of atomic nuclei;
wherein the ion beam is configured to interact with the condensed matter medium so that some atomic nuclei of the first group of atomic nuclei are implanted into the condensed matter medium and undergo a first nuclear reaction thereby releasing a first energy;
wherein the ion beam is further configured to generate high-frequency phonons in the condensed matter medium; and
wherein the high-frequency phonons are configured to interact with the first group and the second group of atomic nuclei and affect nuclear states of the second group of atomic nuclei by transferring the first energy of the first group of atomic nuclei to the second group of atomic nuclei and causing the second group of atomic nuclei to undergo a second nuclear reaction and emit energetic particles.

2. The system of claim 1, wherein the first nuclear reaction comprises fusion of some of the atomic nuclei of the first group of atomic nuclei.

3. The system of claim 1, wherein the ion beam comprises energy in the range of 100 eV to 2000 eV.

4. The system of claim 1, further comprising a particle detector for detecting the emitted energetic particles.

5. The system of claim 1, wherein the condensed matter medium is contained within a vacuum chamber.

6. The system of claim 1, wherein the condensed matter medium comprises a Lithium foil and the second group of atomic nuclei comprises Li-6 nuclei.

7. The system of claim 6, wherein the first group of atomic nuclei comprises deuterium (H-2) and protium (H-1) nuclei.

8. The system of claim 7, wherein the emitted charged particles comprise tritium (H-3) and Helium-4 (He-4) nuclei.

9. The system of claim 1, wherein the first group of atomic nuclei comprises deuterium (H-2) and protium (H-1) nuclei, the second group of atomic nuclei comprises Li-6 nuclei and the first nuclear reaction comprises fusion of the H-2 and H-1 nuclei resulting in emission of 5.5 MeV gamma rays and the second nuclear reaction comprises decay of the Li-6 nuclei resulting in emission of energetic particles having an energy of 1.1 MeV.

10. The system of claim 1, wherein the first group of atomic nuclei comprises deuterium (H-2) and protium (H-1) nuclei, the second group of atomic nuclei comprises Pb-204 nuclei and the first nuclear reaction comprises fusion of the H-2 and H-1 nuclei resulting in emission of 5.5 MeV gamma rays and the second nuclear reaction comprises decay of the Pb-204 nuclei resulting in emission of energetic particles having an energy of 7.3 MeV.

11. The system of claim 1, wherein the first nuclear reaction further emits energetic particles having an energy lower than the energy of the energetic particles that are generated by the second nuclear reaction.

12. A method for generating energetic particles comprising:
generating an ion beam comprising a first group of atomic nuclei;
providing a condensed matter medium comprising a second group of atomic nuclei;
interacting the ion beam with the condensed matter medium so that some atomic nuclei of the first group of atomic nuclei are implanted into the condensed matter medium and undergo a first nuclear reaction thereby releasing a first energy;
wherein the ion beam is further configured to generate high-frequency phonons in the condensed matter medium; and
interacting the high-frequency phonons with the second group of atomic nuclei and affecting nuclear states of the second group of atomic nuclei by transferring the first energy of the first group of atomic nuclei to the second group of atomic nuclei and causing the second group of atomic nuclei to undergo a second nuclear reaction and emit energetic particles.

13. The method of claim 12, wherein the first nuclear reaction comprises fusion of some of the atomic nuclei of the first group of atomic nuclei.

14. The method of claim 12, wherein the ion beam comprises energy in the range of 500 eV to 1000 eV.

15. The method of claim 12, further comprising providing a particle detector for detecting the emitted energetic particles.

16. The method of claim 12, wherein the condensed matter medium is contained within a vacuum chamber.

17. The method of claim 12, wherein the first group of atomic nuclei comprises deuterium (H-2) and protium (H-1) nuclei, the second group of atomic nuclei comprises Li-6 nuclei and the first nuclear reaction comprises fusion of the H-2 and H-1 nuclei resulting in emission of 5.5 MeV gamma rays and the second nuclear reaction comprises decay of the Li-6 nuclei resulting in emission of energetic particles having an energy of 1.1 MeV.

18. The method of claim 12, wherein the first group of atomic nuclei comprises deuterium (H-2) and protium (H-1) nuclei, the second group of atomic nuclei comprises Pb-204 nuclei and the first nuclear reaction comprises fusion of the H-2 and H-1 nuclei resulting in emission of 5.5 MeV gamma rays and the second nuclear reaction comprises decay of the Pb-204 nuclei resulting in emission of energetic particles having an energy of 7.3 MeV.

19. The method of claim 12, wherein the first nuclear reaction further emits energetic particles having an energy lower than the energy of the energetic particles that are generated by the second nuclear reaction.

20. A system for generating energetic particles comprising:
a condensed matter medium comprising a first group of atomic nuclei and a second group of atomic nuclei;
a phonon generator configured to generate high-frequency phonons in the condensed matter medium;
wherein some of the atomic nuclei of the first group undergo a first nuclear reaction thereby releasing a first energy; and
wherein the high-frequency phonons are configured to interact with the first group of atomic nuclei and the second group of atomic nuclei and affect nuclear states of the second group of atomic nuclei by transferring the first energy of the first group of atomic nuclei to the second group of atomic nuclei and causing the second group of atomic nuclei to undergo a second nuclear reaction and emit energetic particles.

21. The system of claim 20, wherein the first nuclear reaction comprises one of fission, fusion, or radioactive decay.

22. The system of claim 1, wherein the energetic particles comprise charged particles.
